(19) United States
(12) Patent Application Publication
(10) Pub. No.: US 2026/0239034 A1
(43) Pub. Date: Aug. 13, 2026

(54) COMMUNICATION METHOD AND APPARATUS, AND STORAGE MEDIUM

(71) Applicant: Beijing Xiaomi Mobile Software Co., Ltd., Beijing (JP)

(72) Inventor: Qin MU, Beijing (CN)

(73) Assignee: Beijing Xiaomi Mobile Software Co., Ltd., Beijing (JP)

(21) Appl. No.: 19/471,039

(22) PCT Filed: Apr. 7, 2023
(86) PCT No.: PCT/CN2023/087083

§ 371 Date: Sep. 30, 2025

(51) Int. Cl. H04W 24/02

(52) U.S. Cl. CPC H04W 24/02

(57) ABSTRACT

The present disclosure relates to a communication method and apparatus, and a storage medium. The method includes: determining a processing duration corresponding to a first operation related to the processing of an artificial intelligence (AI) model. In the present disclosure, a processing duration corresponding to a first operation related to the processing of an AI model is determined, such that it can be ensured that time alignment between a terminal and a network device is realized on the basis of the processing duration. In this way, after the processing duration, the network device or the terminal calls the AI model, which is deployed on the opposite end, to perform corresponding processing, thereby improving the operation efficiency of the A model.

### CROSS REFERENCE

The present application is a U.S. National Stage of International Application No. PCT/CN2023/087083, filed on Apr. 7, 2023, the contents of which are incorporated herein by reference in its entirety for all purposes.

### TECHNICAL FIELD

The present disclosure relates to the field of communication technologies, and in particular to a communication method, a communication device and a storage medium.

### BACKGROUND

The widespread application of 5G technology has brought great changes to all aspects of people's lives. According to the vision of the International Telecommunication Union (ITU), 5G will penetrate into all areas of the future society and build a comprehensive information ecosystem with users as the center. 5G technology can support extreme business experiences such as mobile virtual reality. Also, 5G technology can support a large number of IoT devices, meet the stringent requirements of vehicle networking and industrial control, and can provide good user experience in high-speed rail environments. It can be imagined that 5G, as a representative of new infrastructure, will focus on building the future information society.

In recent years, Artificial Intelligence (AI) technology has made continuous breakthroughs in many fields. The continuous development of fields such as intelligent voice and computer vision brings a variety of rich and colorful applications to smart terminals. It is also widely used in many fields such as education, transportation, home, medical care, retail, and security. While bringing convenience to people's lives, it is also promoting industrial upgrading in various industries.

### SUMMARY

The present disclosure provides a communication method, a communication device and a storage medium.

According to a first aspect of embodiments of the present disclosure, there is provided a communication method, which is performed by a terminal. The method includes: determining a processing duration corresponding to a first operation related to AI model processing.

According to a second aspect of embodiments of the present disclosure, there is provided a communication method, which is performed by a network device. The method includes: determining a processing duration corresponding to a first operation related to AI model processing.

According to a third aspect of embodiments of the present disclosure, there is provided a communication device, including: a processor; and a memory configured to store instructions executable by the processor. The processor is configured to perform the first aspect and any one of the methods in the first aspect.

According to a fourth aspect of embodiments of the present disclosure, there is provided a communication device, including: a processor; and a memory configured to store instructions executable by the processor. The processor is configured to perform the second aspect and any one of the methods in the second aspect.

According to an sixth aspect of embodiments of the present disclosure, there is provided a non-transitory computer-readable storage medium. When instructions in the storage medium are executed by a processor of a terminal, the terminal is enabled to perform the first aspect and any one of the methods in the first aspect.

According to a seventh aspect of embodiments of the present disclosure, there is provided a non-transitory computer-readable storage medium. When instructions in the storage medium are executed by a processor of a network device, the network device is enabled to perform the second aspect and any one of the methods in the second aspect.

It should be understood that the above general description and the detailed description below are only examples and explanatory, and cannot limit the present disclosure.

### BRIEF DESCRIPTION OF THE DRAWINGS

The drawings herein are incorporated into the specification and constitute a part of the specification, illustrate embodiments consistent with the present disclosure, and are used together with the description to explain the principles of the present disclosure.

FIG. 1 shows a schematic diagram of a wireless communication system according to an example embodiment.

FIG. 2 shows a flowchart of a communication method according to an example embodiment.

FIG. 3 shows a flowchart of another communication method according to an example embodiment.

FIG. 4 shows a flowchart of yet another communication method according to an example embodiment.

FIG. 5 shows a flowchart of still another communication method according to an example embodiment.

FIG. 6 shows a flowchart of another communication method according to an example embodiment.

FIG. 7 shows a flowchart of yet another communication method according to an example embodiment.

FIG. 8 shows a flowchart of still another communication method according to an example embodiment.

FIG. 9 shows a flowchart of another communication method according to an example embodiment.

FIG. 10 shows a schematic diagram of a communication device according to an example embodiment.

FIG. 11 shows a schematic diagram of another communication device according to an example embodiment.

FIG. 12 shows a schematic diagram of a communication device according to an example embodiment.

FIG. 13 shows a schematic diagram of another communication device according to an example embodiment.

### DETAILED DESCRIPTION

The example embodiments will be described in detail here, and instances thereof are shown in the accompanying drawings. When the following description refers to the drawings, unless otherwise indicated, the same numbers in different drawings represent the same or similar elements. The implementations described in the following example embodiments do not represent all the implementations consistent with the present disclosure.

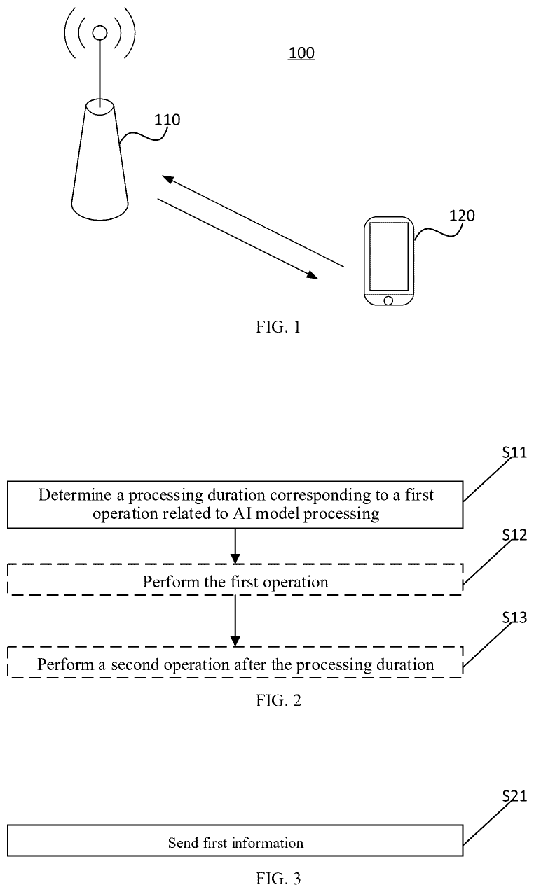

The communication method involved in the present disclosure may be applied to the wireless communication system 100 shown in FIG. 1. The network system may include a network device 110 and a terminal 120. It should be understood that the wireless communication system shown in FIG. 1 is only for schematic illustration. The wireless communication system may also include other network devices, such as core network devices, wireless relay devices, and wireless backhaul devices, which are not shown in FIG. 1. The embodiments of the present disclosure do not limit the number of network devices and the number of terminals included in the wireless communication system.

It should be further understood that the wireless communication system in the embodiments of the present disclosure is a network that provides wireless communication functions. The wireless communication system may adopt different communication technologies, such as Code Division Multiple Access (CDMA), Wideband Code Division Multiple Access (WCDMA), Time Division Multiple Access (TDMA), Frequency Division Multiple Access (FDMA), Orthogonal Frequency-Division Multiple Access (OFDMA), Single Carrier FDMA (SC-FDMA), Carrier Sense Multiple Access with Collision Avoidance. According to the capacity, rate, delay and other factors of different networks, the network may be divided into 2G (2nd Generation) network, 3G network, 4G network or future evolution network, such as the 5th Generation Wireless Communication System (5G) network. The 5G network may also be called New Radio (NR). For the convenience of description, the present disclosure sometimes refers to the wireless communication network as a network.

Further, the network device 110 involved in the present disclosure may also be called a wireless access network device. The wireless access network device may be: a base station, an evolved Node B (eNB), a home base station, an Access Point (AP) in a Wireless Fidelity (WIFI) system, a wireless relay node, a wireless backhaul node, a Transmission Point (TP) or a Transmission and Receiving Point (TRP), etc. It may also be a gNB in an NR system, or be a component or a part of a base station. When it is a vehicle-to-everything (V2X) communication system, the network device may also be a vehicle-mounted device. It should be understood that in the embodiments of the present disclosure, the specific technology and specific device form adopted by the network device are not limited.

Further, the terminal 120 involved in the present disclosure may also be referred to as a terminal device, a User Equipment (UE), a Mobile Station (MS), a Mobile Terminal (MT), etc., which is a device that provides voice and/or data connectivity to a user. For example, the terminal may be a handheld device with a wireless connection function, a vehicle-mounted device, etc. At present, some examples of terminals are: Mobile Phone, Pocket Personal Computers (PPC), handheld computers, Personal Digital Assistants (PDA), laptops, tablet computers, wearable devices, or vehicle-mounted devices. In addition, when it is a vehicle-to-everything (V2X) communication system, the terminal device may also be a vehicle-mounted device. It should be understood that the embodiments of the present disclosure do not limit the specific technology and specific device form adopted by the terminal.

In the embodiments of the present disclosure, the network device 110 and the terminal 120 may use any feasible wireless communication technology to achieve mutual data transmission. The transmission channel corresponding to the data or control information sent by the network device 110 to the terminal 120 is called a downlink channel (downlink, DL). The transmission channel corresponding to the data or control information sent by the terminal 120 to the network device 110 is called an uplink channel (uplink, UL). It should be understood that the network device involved in the embodiments of the present disclosure may be a base station. It shall be noted that the network device may also be any other possible network device, and the terminal may be any possible terminal, which is not limited by the present disclosure.

The widespread application of 5G technology has brought great changes to all the aspects of people's lives. According to the ITU's vision, 5G will penetrate into all the areas of the future society and build a comprehensive information ecosystem with users as the center. The experience rate for 5G users can reach 100 Mbit/s~1 Gbit/s, which can support extreme service experiences such as mobile virtual reality. The 5G peak rate can reach 10 Gbit/s~20 Gbit/s, and the traffic density can reach 10 Mbit/s/m2, which can support the growth of more than a thousand times of mobile service traffic in the future. The 5G connection density can reach 1 million/m2, which can effectively support a large number of IoT devices. The 5G transmission delay can reach the millisecond level, which can meet the stringent requirements of the Internet of Vehicles and industrial control. 5G can support a mobile speed of 500 km/h, which can meet good user experience in the high-speed rail environment. It can be imagined that 5G, as a representative of new infrastructure, will rebuild the future information society.

In recent years, AI technology has made continuous breakthroughs in many fields. The continuous development of fields such as intelligent voice and computer vision not only brings a variety of rich and colorful applications to terminals, but also has wide applications in education, transportation, home, medical care, retail, security and other fields. While bringing convenience to people's lives, it is also promoting industrial upgrading in various industries. AI technology is also accelerating its cross-penetration with other disciplines. The development of AI technology integrates knowledge from different disciplines and provides new directions and methods for the development of different disciplines.

In the 3rd generation partnership project (3GPP) Release 18, a research project on Artificial Intelligence technology in radio air interface was established in Radio Access Network (RAN)1. The project aims to study how to introduce Artificial Intelligence technology in radio air interface, and explore how Artificial Intelligence technology can assist in improving the transmission technology of radio air interface.

For example, in the research of wireless AI, the application cases of Artificial Intelligence include:
Channel State Information (CSI) enhancement based on AI
Beam management based on AI
Positioning based on AI.

In some discussions, there are the following scenarios associated with the models.

Model activation refers to the transition from a non-AI model processing state to a state where an AI model is used for processing.

Model switching refers to the switching from one AI model to another AI model.

There is a method to fall back from AI model processing to non-AI model processing, such as a traditional method in which the AI model is not used for processing.

In addition, there can also exist various types of AI models, such as unilateral models and bilateral models. The unilateral model means all parts of the AI model are deployed on the same device. The AI model can be entirely deployed on the terminal or entirely deployed on the network device. The bilateral model means part of the AI model is deployed on the terminal, while the rest is deployed on the network device. In other words, different parts of the same AI model can be deployed on different devices, respectively. In this case, the AI model's inference calculations require collaboration between the terminal and the network device.

However, enabling or disabling the AI model requires launching the corresponding hardware and software. The network device and the terminal do not know how long it will take from receiving a model management command to executing the model management command.

Therefore, in the present disclosure, a processing duration corresponding to a first operation related to AI model processing is determined, thereby ensuring that the terminal and the network device are time-aligned based on the processing duration. This allows the network device or the terminal to call an AI model deployed on the peer side after the processing duration to perform corresponding processing, thereby improving the operating efficiency of the AI model.

FIG. 2 shows a flowchart of a communication method according to an example embodiment. As shown in FIG. 2, the method is performed by a terminal, and the method may include the following step:
in step S11, a processing duration corresponding to a first operation related to AI model processing is determined.

In some embodiments, the terminal may determine the first operation related to the AI model processing. For example, the first operation may also be referred to as a target operation. It can be understood that the first operation merely represents a name for an operation related to the AI model processing, which is not limited by the present disclosure. The terminal determines the processing duration corresponding to the first operation.

For example, the terminal receives a first operation sent by a network device, and the first operation may be an operation related to the AI model processing. For another example, a user may trigger a first operation through a peripheral device of the terminal, such as a touchscreen or keyboard, so that the terminal can determine the first operation.

When the terminal determines the first operation, it can determine the processing duration corresponding to the first operation. It can be understood that the processing duration can be considered as a duration required for the terminal to perform the above-mentioned first operation. In other words, the terminal can complete the first operation within the above-mentioned processing duration.

Alternatively, in some cases, the first operation may also be performed by the network device. Therefore, in this case, the processing duration corresponding to the first operation can be considered to be a duration required for the network device to perform the first operation. It can be considered that the network device can complete the first operation within the above processing duration. In this example, the terminal determines the duration corresponding to the first operation for the purpose of determining at what time it can send a second operation to the network device, for example, the second operation is used to trigger the network device to perform the corresponding task or perform data processing using an AI model or in a non-AI model manner after the first operation is performed.

In some embodiments, the first operation may be, for example, an operation for activating an AI model, an operation for switching the AI model, and/or an operation for deactivating the AI model.

In some embodiments, the terminal may further include steps S12 and S13.

In the step S12, the first operation is performed.

In some embodiments, the terminal may perform the above-mentioned operation related to the AI model processing.

For example, the first operation is an operation indicating to enable a certain AI model, such as the operation for activating the AI model, and the terminal can activate the relevant AI model.

For another example, the first operation is an operation indicating to switch from an AI model to another AI model, such as the operation for switching the AI model, and the terminal may switch the AI model. For example, a first AI model is running on the terminal, and the terminal may switch the first AI model to a second AI model based on the first operation, so that the terminal can subsequently run the second AI model. It can be understood that the second AI model is another AI model different from the first AI model.

For yet another example, the first operation is an operation indicating to deactivate a certain AI model, such as the operation for deactivating the AI model. The terminal can deactivate the running AI model based on the first operation, so that the terminal can subsequently perform corresponding data processing or perform a certain task in a non-AI model manner.

In the step S13, the second operation is performed after the processing duration.

In some embodiments, upon elapse of the processing duration, the terminal may perform the second operation, and the second operation may be an operation for performing corresponding data processing using the AI model.

It can be understood that the above processing duration is to ensure that the terminal can complete the execution of the first operation. Therefore, after the processing duration, it can be considered that the execution of the first operation is completed. For example, after the processing duration, the terminal can be considered to have completed the first operation. The terminal can receive the second operation, such as the second operation sent by the network device. The second operation can indicate to the terminal to perform the corresponding task or perform data processing using the AI model or in the non-AI model manner after the first operation is executed. For example, if the first operation is the operation for activating the AI model, the terminal can use the activated AI model to perform the corresponding task. For another example, if the first operation is the operation for switching the AI model, the terminal can use the switched AI model to perform the corresponding task. For yet another example, if the first operation is the operation for deactivating the AI model, the terminal can perform the corresponding task in the non-AI model manner.

Alternatively, if the AI model is deployed on the network device, the terminal can determine, based on the above processing duration, that the network device side has completed the execution of the first operation. The terminal can send to the network device information indicating the second operation, and the second operation can be used to indicate to the network device to perform the corresponding task or perform data processing using the AI model or in the non-AI model manner after the first operation is executed.

In the present disclosure, the processing duration corresponding to the first operation related to the AI model processing is determined, thereby ensuring that the terminal and the network device are time-aligned based on the processing duration. This allows the network device or the terminal to call the AI model deployed on the peer side after the processing duration to perform corresponding processing, thereby improving the operating efficiency of the AI model.

In the communication method provided by embodiments of the present disclosure, the first operation includes at least one of: an operation for activating the AI model; an operation for switching the AI model; or an operation for deactivating the AI model.

In some embodiments, the first operation related to the AI model processing includes the operation for activating the AI model.

It can be understood that the first operation can be used to activate a certain AI model. Activating the AI model can be understood as launching a certain AI model.

In some embodiments, the first operation related to the AI model processing includes the operation for switching the AI model.

It can be understood that the first operation can be used to switch the first AI model to the second AI model. The first AI model can be any AI model, and the second AI model can be another AI model different from the first AI model.

In some embodiments, the first operation related to the AI model processing includes the operation for deactivating the AI model.

It can be understood that the first operation can be used to deactivate a certain AI model, and the deactivated AI model cannot be used.

In some embodiments, the first operation related to the AI model processing includes: the operation for activating the AI model and the operation for switching the AI model; or the operation for activating the AI model and the operation for deactivating the AI model; or the operation for switching the AI model and the operation for deactivating the AI model; or the operation for activating the AI model, the operation for switching the AI model and the operation for deactivating the AI model.

The present disclosure provides a variety of first operations related to the AI model processing to determine the processing duration corresponding to the operation, thereby ensuring that the terminal and the network device are time-aligned based on the processing duration. This allows the network device or the terminal to call an AI model deployed on the peer side after the processing duration to perform corresponding processing, thereby improving the operating efficiency of the AI model.

In the communication method provided by embodiments of the present disclosure, different first operations correspond to different processing durations.

In some embodiments, different first operations may correspond to different processing durations. In other words, when the terminal performs different first operations, the corresponding processing durations may be different.

For example, the first operation is the operation for activating the AI model. The terminal needs to switch from a non-AI model processing mode to an AI model-based processing mode, and needs to load the software and hardware environments related to the AI model. Therefore, the terminal needs to take a certain processing time to complete the first operation, that is, the operation for activating the AI model.

For another example, the first operation is the operation for switching the AI model. The terminal needs to switch from a first AI model processing mode to a second AI model processing mode, needs to load the software and hardware environments related to the second AI model and needs to close the software and hardware environments related to the first AI model. Therefore, the terminal needs to take a certain processing time to complete the first operation, that is, the operation for switching the AI model.

For yet another example, the first operation is the operation for deactivating the AI model. The terminal needs to switch from the AI model-based processing mode to the non-AI model processing mode, and needs to close the software and hardware environments related to the AI model. Therefore, the terminal needs to take a certain processing time to complete the first operation, that is, the operation for deactivating the AI model.

Alternatively, when the terminal performs the above-mentioned different first operations, since the operations required by the terminal to load and/or deactivate the AI model are different, the processing durations required for different first operations are also different.

The present disclosure determines different processing durations for different first operations related to the AI model processing, thereby ensuring that the terminal and network device can be time-aligned based on different processing durations for different operations. This allows the network device or the terminal to call an AI model deployed on the peer side after the processing duration to perform corresponding processing, thereby improving the operating efficiency of the AI model.

In the communication method provided by embodiments of the present disclosure, a processing duration corresponding to the operation for activating the AI model is greater than or equal to a processing duration corresponding to the operation for switching the AI model; and/or, a processing duration corresponding to the operation for deactivating the AI model is less than or equal to the processing duration corresponding to the operation for switching the AI model.

In some embodiments, the processing duration corresponding to the operation for activating the AI model is greater than or equal to the processing duration corresponding to the operation for switching the AI model.

That is, the processing duration for the terminal to activate the AI model is longer than the processing duration for the terminal to switch the AI model. Alternatively, the processing duration for the terminal to activate the AI model is equal to the processing duration for the terminal to switch the AI model.

In some embodiments, the processing duration corresponding to the operation for deactivating the AI model is less than or equal to the processing duration corresponding to the operation for switching the AI model.

That is, the processing duration for the terminal to deactivate the AI model is less than the processing duration for the terminal to switch the AI model. Alternatively, the processing duration for the terminal to deactivate the AI model is equal to the processing duration for the terminal to switch the AI model.

The present disclosure provides specific processing duration relationships for different first operations related to the AI model processing, thereby ensuring that the terminal and network device can be time-aligned based on different processing durations for different operations. This allows the network device or the terminal to call an AI model deployed on the peer side after the processing duration to perform corresponding processing, thereby improving the operating efficiency of the AI model.

In the communication method provided by embodiments of the present disclosure, the processing duration corresponding to the first operation varies depending on a deployment mode of the AI model.

In some embodiments, deployment modes of the AI model can be divided into unilateral deployment and bilateral deployment. The unilateral deployment means that the AI model is deployed on one device. For example, it can be deployed on the terminal or the network device. The bilateral deployment means that different parts of the AI model can be deployed on different devices, respectively. For example, the same AI model can be divided into two parts. One part of the AI model can be deployed on the terminal, and the other part of the AI model can be deployed on the network device. Alternatively, in some cases, one part of the AI model can be deployed on terminal A, and the other part of the AI model can be deployed on terminal B; or, one part of the AI model can be deployed on network device A, and the other part of the AI model can be deployed on network device B.

In some embodiments, a processing duration corresponding to a first operation involving a unilaterally deployed AI model may be different from a processing duration corresponding to a first operation involving a bilaterally deployed AI model.

For example, assuming that the first operation is the operation for activating the AI model, a processing duration corresponding to activating the unilaterally deployed AI model is different from a processing duration corresponding to activating the bilaterally deployed AI model.

For another example, assuming that the first operation is the operation for switching the AI model, a processing duration corresponding to switching the unilaterally deployed AI model is different from a processing duration corresponding to switching the bilaterally deployed AI model.

Alternatively, during the operation of switching the AI model, a processing duration corresponding to switching from the unilaterally deployed AI model to the bilaterally deployed AI model may be different from a processing duration corresponding to switching from the bilaterally deployed AI model to the unilaterally deployed AI model.

For yet another example, assuming that the first operation is the operation for deactivating the AI model, a processing duration corresponding to deactivating the unilaterally deployed AI model is different from a processing duration corresponding to deactivating the bilaterally deployed AI model.

The present disclosure determines different processing durations for different AI model deployment modes, thereby ensuring that the terminal and network device can be time-aligned based on different processing durations for different operations. This allows the network device or the terminal to call an AI model deployed on the peer side after the processing duration to perform corresponding processing, thereby improving the operating efficiency of the AI model.

In the communication method provided by embodiments of the present disclosure, the AI model is deployed on the terminal or the network device, and the processing duration corresponding to the first operation is a first processing duration; and the AI model is deployed on the terminal and the network device, and the processing duration corresponding to the first operation is a second processing duration; and processing durations corresponding to first operations being different includes: the first processing duration being less than or equal to the second processing duration.

In some embodiments, the AI model can be deployed on one device, for example, the same AI model is deployed on the terminal or the network device, and the processing duration corresponding to the first operation is referred to as the first processing duration. The AI model can be deployed on multiple devices, for example, different parts of the same AI model are deployed on the terminal and the network device, respectively, or are deployed on different terminals, respectively, or are deployed on different network devices, respectively, and the processing duration corresponding to the first operation is referred to as the second processing duration.

In some embodiments, the first processing duration is less than the second processing duration.

For example, a processing duration corresponding to an operation related to unilaterally deployed AI model processing may be shorter than a processing duration corresponding to an operation related to bilaterally deployed AI model processing.

For example, a processing duration corresponding to activating the unilaterally deployed AI model can be shorter than a processing duration corresponding to activating the bilaterally deployed AI model.

For another example, a processing duration corresponding to switching the unilaterally deployed AI model can be shorter than a processing duration corresponding to switching the bilaterally deployed AI model.

Alternatively, during the operation of switching the AI model, a processing duration corresponding to switching from the unilaterally deployed AI model to the bilaterally deployed AI model may be shorter than a processing duration corresponding to switching from the bilaterally deployed AI model to the unilaterally deployed AI model. Alternatively, a processing duration corresponding to switching from the unilaterally deployed AI model to the bilaterally deployed AI model may be longer than a processing duration corresponding to switching from the bilaterally deployed AI model to the unilaterally deployed AI model.

For yet another example, a processing duration corresponding to deactivating the unilaterally deployed AI model may be shorter than a processing duration corresponding to deactivating the bilaterally deployed AI model.

In some embodiments, the first processing duration is equal to the second processing duration.

For example, the processing duration corresponding to the operation related to the unilaterally deployed AI model processing can be equal to the processing duration corresponding to the operation related to the bilaterally deployed AI model processing.

For example, the processing duration corresponding to activating the unilaterally deployed AI model can be equal to the processing duration corresponding to activating the bilaterally deployed AI model.

For another example, the processing duration corresponding to switching the unilaterally deployed AI model can be equal to the processing duration corresponding to switching the bilaterally deployed AI model.

Alternatively, during the operation of switching the AI model, the processing duration corresponding to switching from the unilaterally deployed AI model to the bilaterally deployed AI model can be equal to the processing duration corresponding to switching from the bilaterally deployed AI model to the unilaterally deployed AI model.

For another example, the processing duration corresponding to deactivating the unilaterally deployed AI model can be equal to the processing duration corresponding to deactivating the bilaterally deployed AI model.

The present disclosure provides specific processing duration relationships for different AI model deployment modes, thereby ensuring that the terminal and network device can be time-aligned based on different processing durations for different operations. This allows the network device or the terminal to call an AI model deployed on the peer side after the processing duration to perform corresponding processing, thereby improving the operating efficiency of the AI model.

In the communication method provided by embodiments of the present disclosure, the processing duration corresponding to the first operation varies depending on an application scenario of the AI model.

In some embodiments, processing durations corresponding to different first operations can be determined based on different application scenarios corresponding to the AI model. It can be understood that the different application scenarios of the AI model can also be considered as different use cases of the AI model.

Assuming that the application scenarios of the AI model include beam prediction scenarios and positioning scenarios, the processing duration corresponding to the first operation in the beam prediction scenario may be different from the processing duration corresponding to the first operation in the positioning scenario.

Alternatively, the application scenarios of the AI model can also include CSI enhancement, etc. The present disclosure does not limit the specific application scenarios of the AI model, nor the number of application scenarios.

The present disclosure determines different processing durations for different application scenarios of the AI model, thereby ensuring that the terminal and network device can be time-aligned based on different processing durations for different operations. This allows the network device or the terminal to call an AI model deployed on the peer side after the processing duration to perform corresponding processing, thereby improving the operating efficiency of the AI model.

In the communication method provided by embodiments of the present disclosure, the processing duration corresponding to the first operation varies depending on a storage space occupied by the AI model; or the processing duration corresponding to the first operation varies depending on a complexity of the AI model.

In some embodiments, different AI models may occupy different storage spaces, in other words, the sizes of the AI models may be different. Therefore, the processing time for performing the first operation on AI models of different sizes may be different.

For example, if a storage space occupied by the first AI model is larger than a storage space occupied by the second AI model, the processing time for performing the first operation on the first AI model may be greater than the processing time for performing the first operation on the second AI model.

In some embodiments, different AI models may correspond to different complexities, and the processing time for performing the first operation on AI models of different complexities may be different.

For example, if the complexity of the first AI model is greater than that of the second AI model, the processing time for performing the first operation on the first AI model may be greater than the processing time for performing the first operation on the second AI model.

In some embodiments, the complexity of the AI model may or may not be related to the storage space occupied by the AI model. For example, if the complexity of the AI model is related to the storage space occupied by the AI model, the higher the complexity of the AI model, the larger the storage space occupied by the AI model.

The present disclosure can determine different processing durations for the different storage space occupied by the AI models or different complexities of the AI models, thereby ensuring that the terminal and network device can be time-aligned based on different processing durations for different operations. This allows the network device or the terminal to call an AI model deployed on the peer side after the processing duration to perform corresponding processing, thereby improving the operating efficiency of the AI model.

In the communication method provided by embodiments of the present disclosure, the processing duration corresponding to the first operation varies depending on a capability corresponding to the terminal.

In some embodiments, different terminals may correspond to different capabilities. For example, terminals may include ordinary terminals and low-capability terminals. Terminals with different capabilities may have different processing durations corresponding to executing the first operation. For example, the capability of the terminal may include any possible capability, such as an AI model processing capability, a hardware capability, and a software capability, which is not limited in the present disclosure.

The low-capability terminal can be called a RedCap terminal.

For example, it is assumed that some terminals may execute the operation for the AI model processing faster, while other terminals may take longer to execute the operation for the AI model processing. Therefore, it can be considered that the capabilities of these terminals are different. Accordingly, the processing durations corresponding to terminals with different capabilities performing the first operation are also different.

It can be understood that different terminals may have different capabilities for different AI models, respectively.

For example, it can be assumed that there are a first terminal and a second terminal. The first terminal and the second terminal have different capabilities, so a processing duration corresponding to the first terminal performing the operation related to the AI model processing can be different from a processing duration corresponding to the second terminal performing the operation related to the AI model processing.

For another example, individual terminals may have different capabilities for different operations related to the AI model processing. For example, a capability of the first terminal to activate the AI model differs from a capability of the second terminal to activate the AI model. Therefore, a processing duration corresponding to the first terminal performing the operation of activating the AI model may be different from a processing duration corresponding to the second terminal performing the operation of activating the AI model. It will be understood that different terminals may also have different capabilities for switching the AI model and deactivating the AI model. For example, a capability of the first terminal to switch the AI model differs from a capability of the second terminal to switch the AI model. Therefore, a processing duration corresponding to the first terminal performing the operation of switching the AI model may be different from a processing duration corresponding to the second terminal performing the operation of switching the AI model. For another example, a capability of the first terminal to deactivate an AI model differs from a capability of the second terminal to deactivate an AI model. Therefore, a processing duration corresponding to the first terminal performing the operation of deactivating the AI model may be different from a processing duration corresponding to the second terminal performing the operation of deactivating the AI model.

For yet another example, individual terminals may also have different capabilities for different deployment modes of the AI model. For example, a capability of the first terminal to execute the unilaterally deployed AI model is different from a capability of the second terminal to execute the unilaterally deployed AI model, and/or, a capability of the first terminal to execute the bilaterally deployed AI model is different from a capability of the second terminal to execute the bilaterally deployed AI model. Assuming that the capability of the first terminal is higher than that of the second terminal, it can be considered that the processing time for the first terminal to execute the unilaterally deployed AI model is less than the processing time for the second terminal to execute the unilaterally deployed AI model, and/or, the processing time for the first terminal to execute the bilaterally deployed AI model is less than the processing time for the second terminal to execute the bilaterally deployed AI model.

For still another example, individual terminals may also have different capabilities for different storage spaces occupied by the AI models or different complexities of the AI models. Assuming the capability of the first terminal is higher than the capability of the second terminal, for AI models occupying the same storage space or having the same complexity, the processing time for the first terminal to execute the AI model may be less than the processing time for the second terminal to execute the AI model.

It can be understood that the higher the capability of the terminal is, the shorter the processing duration corresponding to the terminal performing the operation can be.

In some embodiments, the terminal may also have corresponding capabilities based on any possible AI model configuration, such as different application scenarios of the AI model, which is not limited in the present disclosure.

The present disclosure can determine different processing durations for different terminal capabilities, thereby ensuring that the terminal and network device can be time-aligned based on different processing durations for different operations. This allows the network device or the terminal to call an AI model deployed on the peer side after the processing duration to perform corresponding processing, thereby improving the operating efficiency of the AI model.

In the communication method provided by embodiments of the present disclosure, FIG. 3 shows a flowchart of another communication method according to an example embodiment. As shown in FIG. 3, the method may further include the following step:
in step S21, first information is sent.

In some embodiments, the terminal may send the first information, and the first information is used to indicate a capability corresponding to the terminal and/or a processing duration corresponding to a first operation supported by the capability.

For example, the terminal sends the first information indicating the capability corresponding to the terminal. A device receiving the first information, such as the network device, can determine, based on the capability corresponding to the terminal indicated in the first information, the processing duration corresponding to the terminal performing the first operation.

For another example, the terminal sends the first information indicating the processing duration corresponding to the first operation supported by the capability corresponding to the terminal. The device receiving the first information, such as the network device, can directly determine, based on the first information, the processing duration corresponding to the terminal performing the first operation.

For yet another example, the terminal sends the first information indicating the capability corresponding to the terminal and the processing duration corresponding to the first operation supported by the capability. The device receiving the first information, such as the network device, can directly determine, based on the first information, the processing duration corresponding to the terminal performing the first operation.

In the present disclosure, the terminal can report its own capability and/or the processing duration corresponding to the first operation corresponding to the capability, so that the network device can call, based on the information reported by the terminal, the AI model deployed on the terminal after the processing duration, so as to perform corresponding processing, thereby improving the operating efficiency of the AI model.

In the communication method provided by embodiments of the present disclosure, the processing duration corresponding to the first operation varies depending on a terminal operation status corresponding to the terminal.

In some embodiments, the terminal operation status may include, for example, the current available computing power, a battery level, etc. of the terminal. It can be understood that the terminal operation status is used to describe the current usage status of the terminal, or the current operation status of the terminal. The processing duration corresponding to the first operation may be different for different terminal operation statuses of the terminal.

For example, when the terminal currently has sufficient available computing power, the processing time corresponding to the first operation can be shorter, while when the terminal has insufficient available computing power, the processing time corresponding to the first operation can be longer. In other words, it can be considered that the more available computing power the terminal has, the shorter the processing duration corresponding to the terminal performing the first operation can be.

For another example, when the terminal currently has the sufficient battery level, the processing time corresponding to the first operation may be shorter, while when the terminal has the insufficient battery level, the processing time corresponding to the first operation may be longer. In other words, it can be considered that the more battery level the terminal has, the shorter the processing duration corresponding to the terminal performing the first operation can be.

The present disclosure can determine different processing durations for different terminal operation statuses, thereby ensuring that the terminal and network device can be time-aligned based on different processing durations for different operations. This allows the network device or the terminal to call an AI model deployed on the peer side after the processing duration to perform corresponding processing, thereby improving the operating efficiency of the AI model.

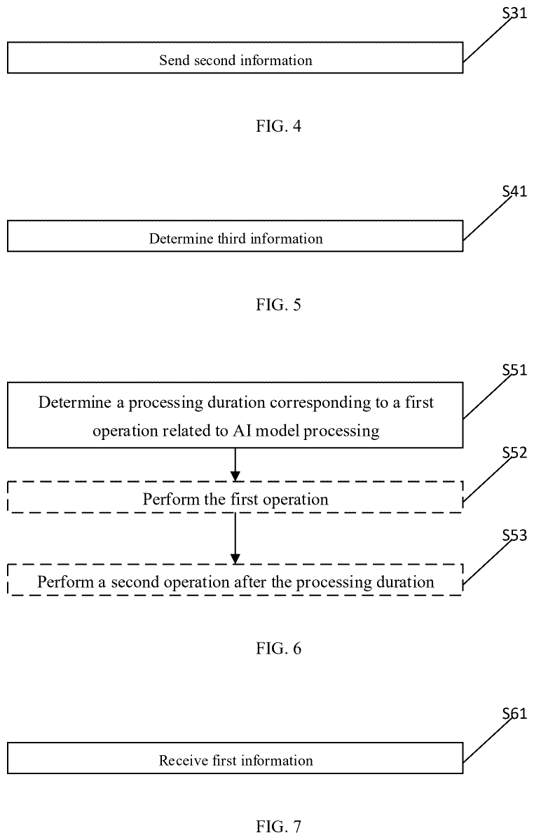

In the communication method provided by embodiments of the present disclosure, FIG. 4 shows a flowchart of yet another communication method according to an example embodiment. As shown in FIG. 4, the method may further include the following step:
in step S31, second information is sent.

In some embodiments, the terminal may send the second information, and the second information is used to indicate a terminal operation status corresponding to the terminal and/or a processing duration corresponding to a first operation supported by the terminal operation status.

For example, the terminal sends the second information indicating the terminal operation status corresponding to the terminal. A device receiving the second information, such as the network device, can determine, based on the terminal operation status corresponding to the terminal indicated in the second information, a processing duration corresponding to the terminal performing the first operation in the terminal operation status.

For another example, the terminal sends the second information indicating the processing duration corresponding to the first operation supported by the terminal operation status corresponding to the terminal. The device receiving the second information, such as the network device, can directly determine, based on the second information, the processing duration corresponding to the terminal performing the first operation in the terminal operation status.

For yet another example, the terminal sends the second information indicating the terminal operation status corresponding to the terminal and the processing duration corresponding to the first operation supported by the terminal operation status. The device receiving the second information, such as the network device, can directly determine, based on the second information, the processing duration corresponding to the terminal performing the first operation in the terminal operation status.

In the present disclosure, the terminal can report the terminal operation status and/or the processing duration corresponding to the first operation supported by the terminal operation status, so that the network device can call, based on the information reported by the terminal, the AI model deployed on the terminal after the processing duration, so as to perform corresponding processing, thereby improving the operating efficiency of the AI model.

In the communication method provided by embodiments of the present disclosure, FIG. 5 shows a flowchart of still another communication method according to an example embodiment. As shown in FIG. 5, the method may further include the following step:
in step S41, third information is determined.

In some embodiments, the terminal may determine the third information, and the third information is used to indicate an AI model deployed on the terminal and/or the network device, and/or to indicate an application scenario of the AI model.

The third information can also be called description information of the AI model, which can be used to describe functions, configurations and other information of the relevant AI model. Therefore, for the AI model deployed on the terminal side, the terminal can directly determine the description information of the relevant AI model. For the AI model deployed on the network device side, the terminal can receive the third information sent by the network device to determine the functions, configurations, etc. of the relevant AI model. Alternatively, for the bilaterally deployed AI model, the terminal can also receive the third information, which can be used only to describe the part of the AI model deployed on the network device side, or can be used to describe the complete AI model, which is not limited in the present disclosure.

For example, for the AI model deployed on the terminal side, the terminal sends the third information indicating the AI model. A device receiving the third information, such as the network device, can determine, based on the AI model indicated in the third information, the processing duration corresponding to the terminal performing the first operation for processing the AI model.

For another example, for the AI model deployed on the terminal side, the terminal sends the third information indicating the application scenario of the AI model or the functionality of the AI model. The device receiving the third information, such as the network device, can determine, based on the third information, the processing duration corresponding to the terminal performing the first operation for processing the AI model.

For example, for the AI model deployed on the network device side, the terminal receives the third information indicating the AI model, so that the terminal can determine, based on the AI model indicated in the third information, the processing duration corresponding to the network device performing the first operation for processing the AI model.

For another example, for the AI model deployed on the network device side, the terminal receives the third information indicating the application scenario of the AI model or the functionality of the AI model, so that the terminal can determine, based on the third information, the processing duration corresponding to the network device performing the first operation for processing the AI model.

It can be understood that the functionality of the AI model and the application scenario of the AI model can have the same meaning, which is used to distinguish the AI model for beam prediction, beam management, positioning, and other scenarios. The present disclosure does not limit the specific functionality or specific application scenario of the AI model.

In the present disclosure, the terminal can determine the AI model and/or the application scenario of the AI model, so that the terminal can call, based on the above information, the AI model deployed on the network device after the processing duration, so as to perform the corresponding processing, thereby improving the operating efficiency of the AI model.

In the communication method provided by embodiments of the present disclosure, the method may further include: performing the second operation based on the processing duration corresponding to the first operation, and the second operation is configured to indicate to the terminal to use an AI model manner or a non-AI model manner to process data, and an AI model corresponding to the AI model manner is an AI model after the first operation is performed by the terminal.

In the communication method provided by embodiments of the present disclosure, the method may further include: receiving fourth information based on the processing duration corresponding to the first operation, and the fourth information is configured to indicate the second operation, the second operation is configured to indicate to the terminal to use the AI model manner or the non-AI model manner to process data, and the AI model corresponding to the AI model manner is the AI model after the first operation is performed by the terminal.

Based on the same concept, the present disclosure further provides a communication method performed on the network device side.

FIG. 6 shows a flowchart of another communication method according to an example embodiment. As shown in FIG. 6, the method is performed by a network device, and the method may include the following step:
in step S51, a processing duration corresponding to a first operation related to AI model processing is determined.

In some embodiments, the network device may determine the first operation related to the AI model processing. For example, the first operation may also be referred to as a target operation. It can be understood that the first operation merely represents a name for an operation related to the AI model processing, which is not limited by the present disclosure. The network device determines the processing duration corresponding to the first operation.

For example, the network device receives a first operation sent by a terminal, and the first operation may be an operation related to the AI model processing. For another example, the network device may generate the first operation, for example, based on a preset rule or receiving the first operation sent from another device, or the network device may generate the first operation by triggering some peripheral devices, etc., which is not limited in the present disclosure.

When the network device determines the first operation, it can determine the processing duration corresponding to the first operation. It can be understood that the processing duration can be considered as a duration required for the network device to perform the above-mentioned first operation. In other words, the network device can complete the first operation within the above-mentioned processing duration.

Alternatively, in some cases, the first operation may also be performed by the terminal. Therefore, in this case, the processing duration corresponding to the first operation can be considered to be a duration required for the terminal to perform the first operation. It can be considered that the terminal can complete the first operation within the above processing duration. In this example, the network device determines the duration corresponding to the first operation for the purpose of determining at what time it can send a second operation to the terminal, for example, the second operation is used to trigger the terminal to perform the corresponding task or perform data processing using an AI model or in a non-AI model manner after the first operation is performed.

In some embodiments, the first operation may be, for example, an operation for activating an AI model, an operation for switching the AI model, and/or an operation for deactivating the AI model.

In some embodiments, the network device may further include steps S52 and S53.

In the step S52, the first operation is performed.

In some embodiments, the network device may perform the above-described operation related to the AI model processing.

For example, the first operation is an operation indicating to enable a certain AI model, such as the operation for activating the AI model, and the network device can activate the relevant AI model.

For another example, the first operation is an operation indicating to switch from an AI model to another AI model, such as the operation for switching the AI model, and the network device may switch the AI model. For example, a first AI model is running on the network device, and the network device may switch the first AI model to a second AI model based on the first operation, so that the network device can subsequently run the second AI model. It can be understood that the second AI model is another AI model different from the first AI model.

For yet another example, the first operation is an operation indicating to deactivate a certain AI model, such as the operation for deactivating the AI model. The network device can deactivate the running AI model based on the first operation, so that the network device can subsequently perform corresponding data processing or perform a certain task in a non-AI model manner.

In the step S53, the second operation is performed after the processing duration.

In some embodiments, upon elapse of the processing duration, the network device may perform the second operation, and the second operation may be an operation for performing corresponding data processing using the AI model.

It can be understood that the above processing duration is to ensure that the network device can complete the execution of the first operation. Therefore, after the processing duration, it can be considered that the execution of the first operation is completed. For example, after the processing duration, the network device can be considered to have completed the first operation. The network device can receive the second operation, such as the second operation sent by the terminal. The second operation can indicate to the network device to perform the corresponding task or perform data processing using the AI model or in the non-AI model manner after the first operation is executed. For example, if the first operation is the operation for activating the AI model, the network device can use the activated AI model to perform the corresponding task. For another example, if the first operation is the operation for switching the AI model, the network device can use the switched AI model to perform the corresponding task. For yet another example, if the first operation is the operation for deactivating the AI model, the network device can perform the corresponding task in the non-AI model manner.

Alternatively, if the AI model is deployed on the terminal, the network device can determine, based on the above processing duration, that the terminal side has completed the execution of the first operation. The network device can send to the terminal information indicating the second operation, and the second operation can be used to indicate to the terminal to perform the corresponding task or perform data processing using the AI model or in the non-AI model manner after the first operation is executed.

In the present disclosure, the processing duration corresponding to the first operation related to the AI model processing is determined, thereby ensuring that the terminal and the network device are time-aligned based on the processing duration. This allows the network device or the terminal to call the AI model deployed on the peer side after the processing duration to perform corresponding processing, thereby improving the operating efficiency of the AI model.

In the communication method provided by embodiments of the present disclosure, the first operation includes at least one of: an operation for activating the AI model; an operation for switching the AI model; or an operation for deactivating the AI model.

In some embodiments, the first operation related to the AI model processing includes the operation for activating the AI model.

It can be understood that the first operation can be used to activate a certain AI model. Activating the AI model can be understood as launching a certain AI model.

In some embodiments, the first operation related to the AI model processing includes the operation for switching the AI model.

It can be understood that the first operation can be used to switch the first AI model to the second AI model. The first AI model can be any AI model, and the second AI model can be another AI model different from the first AI model.

In some embodiments, the first operation related to the AI model processing includes the operation for deactivating the AI model.

It can be understood that the first operation can be used to deactivate a certain AI model, and the deactivated AI model cannot be used.

In some embodiments, the first operation related to the AI model processing includes: the operation for activating the AI model and the operation for switching the AI model; or the operation for activating the AI model and the operation for deactivating the AI model; or the operation for switching the AI model and the operation for deactivating the AI model; or the operation for activating the AI model, the operation for switching the AI model and the operation for deactivating the AI model.

The present disclosure provides a variety of first operations related to the AI model processing to determine the processing duration corresponding to the operation, thereby ensuring that the terminal and the network device are time-aligned based on the processing duration. This allows the network device or the terminal to call an AI model deployed on the peer side after the processing duration to perform corresponding processing, thereby improving the operating efficiency of the AI model.

In the communication method provided by embodiments of the present disclosure, different first operations correspond to different processing durations.

In some embodiments, different first operations may correspond to different processing durations. In other words, when the network device performs different first operations, the corresponding processing durations may be different.

For example, the first operation is the operation for activating the AI model. The network device needs to switch from a non-AI model processing mode to an AI model-based processing mode, and needs to load the software and hardware environments related to the AI model. Therefore, the network device needs to take a certain processing time to complete the first operation, that is, the operation for activating the AI model.

For another example, the first operation is the operation for switching the AI model. The network device needs to switch from a first AI model processing mode to a second AI model processing mode, needs to load the software and hardware environments related to the second AI model and needs to close the software and hardware environments related to the first AI model. Therefore, the network device needs to take a certain processing time to complete the first operation, that is, the operation for switching the AI model.

For yet another example, the first operation is the operation for deactivating the AI model. The network device needs to switch from the AI model-based processing mode to the non-AI model processing mode, and needs to close the software and hardware environments related to the AI model. Therefore, the network device needs to take a certain processing time to complete the first operation, that is, the operation for deactivating the AI model.

Alternatively, when the network device performs the above-mentioned different first operations, since the operations required by the network device to load and/or deactivate the AI model are different, the processing durations required for different first operations are also different.

The present disclosure determines different processing durations for different first operations related to the AI model processing, thereby ensuring that the terminal and network device can be time-aligned based on different processing durations for different operations. This allows the network device or the terminal to call an AI model deployed on the peer side after the processing duration to perform corresponding processing, thereby improving the operating efficiency of the AI model.

In the communication method provided by embodiments of the present disclosure, a processing duration corresponding to the operation for activating the AI model is greater than or equal to a processing duration corresponding to the operation for switching the AI model; and/or, a processing duration corresponding to the operation for deactivating the AI model is less than or equal to the processing duration corresponding to the operation for switching the AI model.

In some embodiments, the processing duration corresponding to the operation for activating the AI model is greater than or equal to the processing duration corresponding to the operation for switching the AI model.

That is, the processing duration for the network device to activate the AI model is longer than the processing duration for the network device to switch the AI model. Alternatively, the processing duration for the network device to activate the AI model is equal to the processing duration for the network device to switch the AI model.

In some embodiments, the processing duration corresponding to the operation for deactivating the AI model is less than or equal to the processing duration corresponding to the operation for switching the AI model.

That is, the processing duration for the network device to deactivate the AI model is less than the processing duration for the network device to switch the AI model. Alternatively, the processing duration for the network device to deactivate the AI model is equal to the processing duration for the network device to switch the AI model.

The present disclosure provides specific processing duration relationships for different first operations related to the AI model processing, thereby ensuring that the terminal and network device can be time-aligned based on different processing durations for different operations. This allows the network device or the terminal to call an AI model deployed on the peer side after the processing duration to perform corresponding processing, thereby improving the operating efficiency of the AI model.

In the communication method provided by embodiments of the present disclosure, the processing duration corresponding to the first operation varies depending on a deployment mode of the AI model.

In some embodiments, deployment modes of the AI model can be divided into unilateral deployment and bilateral deployment. The unilateral deployment means that the AI model is deployed on one device. For example, it can be deployed on the terminal or the network device. The bilateral deployment means that different parts of the AI model can be deployed on different devices, respectively. For example, the same AI model can be divided into two parts. One part of the AI model can be deployed on the terminal, and the other part of the AI model can be deployed on the network device. Alternatively, in some cases, one part of the AI model can be deployed on terminal A, and the other part of the AI model can be deployed on terminal B; or, one part of the AI model can be deployed on network device A, and the other part of the AI model can be deployed on network device B.

In some embodiments, a processing duration corresponding to a first operation involving a unilaterally deployed AI model may be different from a processing duration corresponding to a first operation involving a bilaterally deployed AI model.

For example, assuming that the first operation is the operation for activating the AI model, a processing duration corresponding to activating the unilaterally deployed AI model is different from a processing duration corresponding to activating the bilaterally deployed AI model.

For another example, assuming that the first operation is the operation for switching the AI model, a processing duration corresponding to switching the unilaterally deployed AI model is different from a processing duration corresponding to switching the bilaterally deployed AI model.

Alternatively, during the operation of switching the AI model, a processing duration corresponding to switching from the unilaterally deployed AI model to the bilaterally deployed AI model may be different from a processing duration corresponding to switching from the bilaterally deployed AI model to the unilaterally deployed AI model.

For yet another example, assuming that the first operation is the operation for deactivating the AI model, a processing duration corresponding to deactivating the unilaterally deployed AI model is different from a processing duration corresponding to deactivating the bilaterally deployed AI model.

The present disclosure determines different processing durations for different AI model deployment modes, thereby ensuring that the terminal and network device can be time-aligned based on different processing durations for different operations. This allows the network device or the terminal to call an AI model deployed on the peer side after the processing duration to perform corresponding processing, thereby improving the operating efficiency of the AI model.

In the communication method provided by embodiments of the present disclosure, the AI model is deployed on the terminal or the network device, and the processing duration corresponding to the first operation is a first processing duration; and the AI model is deployed on the terminal and the network device, and the processing duration corresponding to the first operation is a second processing duration; and processing durations corresponding to first operations being different includes: the first processing duration being less than or equal to the second processing duration.

In some embodiments, the AI model can be deployed on one device, for example, the same AI model is deployed on the terminal or the network device, and the processing duration corresponding to the first operation is referred to as the first processing duration. The AI model can be deployed on multiple devices, for example, different parts of the same AI model are deployed on the terminal and the network device, respectively, or are deployed on different terminals, respectively, or are deployed on different network devices, respectively, and the processing duration corresponding to the first operation is referred to as the second processing duration.

In some embodiments, the first processing duration is less than the second processing duration.

For example, a processing duration corresponding to an operation related to unilaterally deployed AI model processing may be shorter than a processing duration corresponding to an operation related to bilaterally deployed AI model processing.

For example, a processing duration corresponding to activating the unilaterally deployed AI model can be shorter than a processing duration corresponding to activating the bilaterally deployed AI model.

For another example, a processing duration corresponding to switching the unilaterally deployed AI model can be shorter than a processing duration corresponding to switching the bilaterally deployed AI model.

Alternatively, during the operation of switching the AI model, a processing duration corresponding to switching from the unilaterally deployed AI model to the bilaterally deployed AI model may be shorter than a processing duration corresponding to switching from the bilaterally deployed AI model to the unilaterally deployed AI model. Alternatively, a processing duration corresponding to switching from the unilaterally deployed AI model to the bilaterally deployed AI model may be longer than a processing duration corresponding to switching from the bilaterally deployed AI model to the unilaterally deployed AI model.

For yet another example, a processing duration corresponding to deactivating the unilaterally deployed AI model may be shorter than a processing duration corresponding to deactivating the bilaterally deployed AI model.

In some embodiments, the first processing duration is equal to the second processing duration.

For example, the processing duration corresponding to the operation related to the unilaterally deployed AI model processing can be equal to the processing duration corresponding to the operation related to the bilaterally deployed AI model processing.

For example, the processing duration corresponding to activating the unilaterally deployed AI model can be equal to the processing duration corresponding to activating the bilaterally deployed AI model.

For another example, the processing duration corresponding to switching the unilaterally deployed AI model can be equal to the processing duration corresponding to switching the bilaterally deployed AI model.

Alternatively, during the operation of switching the AI model, the processing duration corresponding to switching from the unilaterally deployed AI model to the bilaterally deployed AI model can be equal to the processing duration corresponding to switching from the bilaterally deployed AI model to the unilaterally deployed AI model.

For another example, the processing duration corresponding to deactivating the unilaterally deployed AI model can be equal to the processing duration corresponding to deactivating the bilaterally deployed AI model.

The present disclosure provides specific processing duration relationships for different AI model deployment modes, thereby ensuring that the terminal and network device can be time-aligned based on different processing durations for different operations. This allows the network device or the terminal to call an AI model deployed on the peer side after the processing duration to perform corresponding processing, thereby improving the operating efficiency of the AI model.

In the communication method provided by embodiments of the present disclosure, the processing duration corresponding to the first operation varies depending on an application scenario of the AI model.

In some embodiments, processing durations corresponding to different first operations can be determined based on different application scenarios corresponding to the AI model. It can be understood that the different application scenarios of the AI model can also be considered as different use cases of the AI model.

Assuming that the application scenarios of the AI model include beam prediction scenarios and positioning scenarios, the processing duration corresponding to the first operation in the beam prediction scenario may be different from the processing duration corresponding to the first operation in the positioning scenario.

Alternatively, the application scenarios of the AI model can also include CSI enhancement, etc. The present disclosure does not limit the specific application scenarios of the AI model, nor the number of application scenarios.

The present disclosure determines different processing durations for different application scenarios of the AI model, thereby ensuring that the terminal and network device can be time-aligned based on different processing durations for different operations. This allows the network device or the terminal to call an AI model deployed on the peer side after the processing duration to perform corresponding processing, thereby improving the operating efficiency of the AI model.

In the communication method provided by embodiments of the present disclosure, the processing duration corresponding to the first operation varies depending on a storage space occupied by the AI model; or the processing duration corresponding to the first operation varies depending on a complexity of the AI model.

In some embodiments, different AI models may occupy different storage spaces, in other words, the sizes of the AI models may be different. Therefore, the processing time for performing the first operation on AI models of different sizes may be different.

For example, if a storage space occupied by the first AI model is larger than a storage space occupied by the second AI model, the processing time for performing the first operation on the first AI model may be greater than the processing time for performing the first operation on the second AI model.

In some embodiments, different AI models may correspond to different complexities, and the processing time for performing the first operation on AI models of different complexities may be different.

For example, if the complexity of the first AI model is greater than that of the second AI model, the processing time for performing the operation on the first AI model may be greater than the processing time for performing the first operation on the second AI model.

In some embodiments, the complexity of the AI model may or may not be related to the storage space occupied by the AI model. For example, if the complexity of the AI model is related to the storage space occupied by the AI model, the higher the complexity of the AI model, the larger the storage space occupied by the AI model.

The present disclosure can determine different processing durations for the different storage space occupied by the AI models or different complexities of the AI models, thereby ensuring that the terminal and network device can be time-aligned based on different processing durations for different operations. This allows the network device or the terminal to call an AI model deployed on the peer side after the processing duration to perform corresponding processing, thereby improving the operating efficiency of the AI model.

In the communication method provided by embodiments of the present disclosure, the processing duration corresponding to the first operation varies depending on a capability corresponding to the terminal.

In some embodiments, different terminals may correspond to different capabilities. For example, terminals may include ordinary terminals and low-capability terminals. Terminals with different capabilities may have different processing durations corresponding to executing the first operation. For example, the capability of the terminal may include any possible capability, such as an AI model processing capability, a hardware capability, and a software capability, which is not limited in the present disclosure.

The low-capability terminal can be called a RedCap terminal.

For example, it is assumed that some terminals may execute the operation for the AI model processing faster, while other terminals may take longer to execute the operation for the AI model processing. Therefore, it can be considered that the capabilities of these terminals are different. Accordingly, the processing durations corresponding to terminals with different capabilities performing the first operation are also different.

It can be understood that different terminals may have different capabilities for different AI models, respectively.

For example, it can be assumed that there are a first terminal and a second terminal. The first terminal and the second terminal have different capabilities, so a processing duration corresponding to the first terminal performing the operation related to the AI model processing can be different from a processing duration corresponding to the second terminal performing the operation related to the AI model processing.

For another example, individual terminals may have different capabilities for different operations related to the AI model processing. For example, a capability of the first terminal to activate the AI model differs from a capability of the second terminal to activate the AI model. Therefore, a processing duration corresponding to the first terminal performing the operation of activating the AI model may be different from a processing duration corresponding to the second terminal performing the operation of activating the AI model. It will be understood that different terminals may also have different capabilities for switching the AI model and deactivating the AI model. For example, a capability of the first terminal to switch the AI model differs from a capability of the second terminal to switch the AI model. Therefore, a processing duration corresponding to the first terminal performing the operation of switching the AI model may be different from a processing duration corresponding to the second terminal performing the operation of switching the AI model. For another example, a capability of the first terminal to deactivate an AI model differs from a capability of the second terminal to deactivate an AI model. Therefore, a processing duration corresponding to the first terminal performing the operation of deactivating the AI model may be different from a processing duration corresponding to the second terminal performing the operation of deactivating the AI model.

For yet another example, individual terminals may also have different capabilities for different deployment modes of the AI model. For example, a capability of the first terminal to execute the unilaterally deployed AI model is different from a capability of the second terminal to execute the unilaterally deployed AI model, and/or, a capability of the first terminal to execute the bilaterally deployed AI model is different from a capability of the second terminal to execute the bilaterally deployed AI model. Assuming that the capability of the first terminal is higher than that of the second terminal, it can be considered that the processing time for the first terminal to execute the unilaterally deployed AI model is less than the processing time for the second terminal to execute the unilaterally deployed AI model, and/or, the processing time for the first terminal to execute the bilaterally deployed AI model is less than the processing time for the second terminal to execute the bilaterally deployed AI model.

For still another example, individual terminals may also have different capabilities for different storage spaces occupied by the AI models or different complexities of the AI models. Assuming the capability of the first terminal is higher than the capability of the second terminal, for AI models occupying the same storage space or having the same complexity, the processing time for the first terminal to execute the AI model may be less than the processing time for the second terminal to execute the AI model.

It can be understood that the higher the capability of the terminal is, the shorter the processing duration corresponding to the terminal performing the operation can be.

In some embodiments, the terminal may also have corresponding capabilities based on any possible AI model configuration, such as different application scenarios of the AI model, which is not limited in the present disclosure.

The present disclosure can determine different processing durations for different terminal capabilities, thereby ensuring that the terminal and network device can be time-aligned based on different processing durations for different operations. This allows the network device or the terminal to call an AI model deployed on the peer side after the processing duration to perform corresponding processing, thereby improving the operating efficiency of the AI model.

In the communication method provided by embodiments of the present disclosure, FIG. 7 shows a flowchart of yet another communication method according to an example embodiment. As shown in FIG. 7, the method may further include the following step:
in step S61, first information is received.

In some embodiments, the network device may receive the first information, and the first information is used to indicate a capability corresponding to the terminal and/or a processing duration corresponding to a first operation supported by the capability.

For example, the network device receives the first information indicating the capability corresponding to the terminal, so that the network device can determine, according to the capability corresponding to the terminal indicated in the first information, the processing duration corresponding to the terminal performing the first operation.

For another example, the network device receives the first information indicating the processing duration corresponding to the first operation supported by the capability corresponding to the terminal, so that the network device can directly determine, based on the first information, the processing duration corresponding to the terminal performing the first operation.

For yet another example, the network device receives the first information indicating the capability corresponding to the terminal and the processing duration corresponding to the first operation supported by the capability, so that the network device can directly determine, based on the first information, the processing duration corresponding to the terminal performing the first operation.

In the present disclosure, the network device can receive the terminal's capability and/or the processing duration corresponding to the first operation corresponding to the capability that are reported by the terminal, so that the network device can call, based on the information reported by the terminal, the AI model deployed on the terminal after the processing duration, so as to perform corresponding processing, thereby improving the operating efficiency of the AI model.

In the communication method provided by embodiments of the present disclosure, the processing duration corresponding to the first operation varies depending on a terminal operation status corresponding to the terminal.

In some embodiments, the terminal operation status may include, for example, the current available computing power, a battery level, etc. of the terminal. It can be understood that the terminal operation status is used to describe the current usage status of the terminal, or the current operation status of the terminal. The processing duration corresponding to the first operation may be different for different terminal operation statuses of the terminal.

For example, when the terminal currently has sufficient available computing power, the processing time corresponding to the first operation can be shorter, while when the terminal has insufficient available computing power, the processing time corresponding to the first operation can be longer. In other words, it can be considered that the more available computing power the terminal has, the shorter the processing duration corresponding to the terminal performing the first operation can be.

For another example, when the terminal currently has the sufficient battery level, the processing time corresponding to the first operation may be shorter, while when the terminal has the insufficient battery level, the processing time corresponding to the first operation may be longer. In other words, it can be considered that the more battery level the terminal has, the shorter the processing duration corresponding to the terminal performing the first operation can be.

The present disclosure can determine different processing durations for different terminal operation statuses, thereby ensuring that the terminal and network device can be time-aligned based on different processing durations for different operations. This allows the network device or the terminal to call an AI model deployed on the peer side after the processing duration to perform corresponding processing, thereby improving the operating efficiency of the AI model.

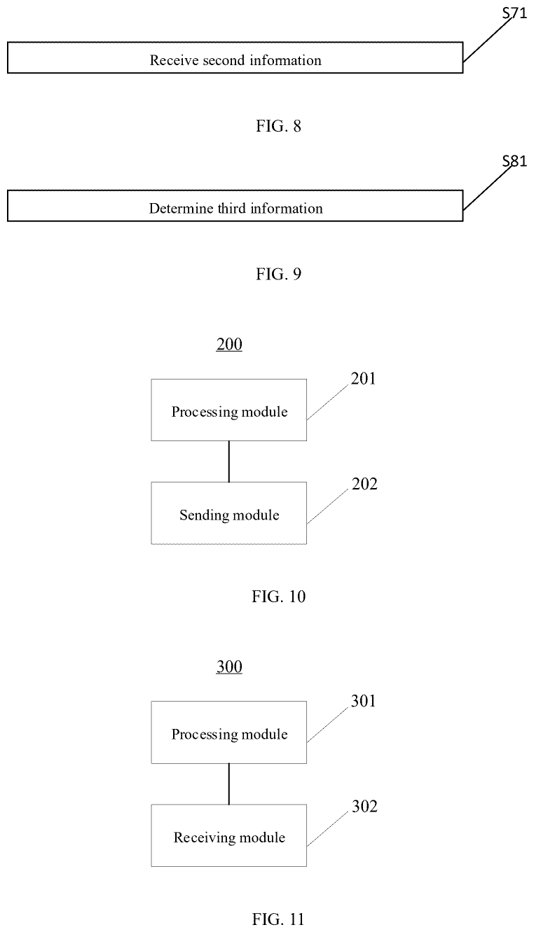

In the communication method provided by embodiments of the present disclosure, FIG. 8 shows a flowchart of still another communication method according to an example embodiment. As shown in FIG. 8, the method may further include the following step:
in step S71, second information is received.

In some embodiments, the network device may receive the second information, and the second information is used to indicate a terminal operation status corresponding to the terminal and/or a processing duration corresponding to a first operation supported by the terminal operation status.

For example, the network device receives the second information indicating the terminal operation status corresponding to the terminal, so that the network device can determine, according to the terminal operation status corresponding to the terminal indicated in the second information, the processing duration corresponding to the terminal performing the first operation in the terminal operation status.

For another example, the network device receives the second information indicating the processing duration corresponding to the first operation supported by the terminal operation status corresponding to the terminal, so that the network device can directly determine, based on the second information, the processing duration corresponding to the terminal performing the first operation in the terminal operation status.

For yet another example, the network device receives the second information indicating the terminal operation status corresponding to the terminal and the processing duration corresponding to the first operation supported by the terminal operation status, so that the network device can directly determine, based on the second information, the processing duration corresponding to the terminal performing the first operation in the terminal operation status.

In the present disclosure, the network device can receive the terminal operation status and/or the processing duration corresponding to the first operation supported by the terminal operation status which are reported by the terminal, so that the network device can call, based on the information reported by the terminal, the AI model deployed on the terminal after the processing duration, so as to perform corresponding processing, thereby improving the operating efficiency of the AI model.

In the communication method provided by embodiments of the present disclosure, FIG. 9 shows a flowchart of another communication method according to an example embodiment. As shown in FIG. 9, the method may further include the following step:
in step S81, third information is determined.

In some embodiments, the network device may determine the third information, and the third information is used to indicate an AI model deployed on the terminal and/or the network device, and/or to indicate an application scenario of the AI model.

The third information can also be called description information of the AI model, which can be used to describe functions, configurations and other information of the relevant AI model. Therefore, for the AI model deployed on the network device side, the network device can directly determine the description information of the relevant AI model. For the AI model deployed on the terminal side, the network device can receive the third information sent by the terminal to determine the functions, configurations, etc. of the relevant AI model. Alternatively, for the bilaterally deployed AI model, the network device can also receive the third information, which can be used only to describe the part of the AI model deployed on the terminal side, or can be used to describe the complete AI model, which is not limited in the present disclosure.

For example, for the AI model deployed on the network device side, the network device sends the third information indicating the AI model. A device receiving the third information, such as the terminal, can determine, based on the AI model indicated in the third information, the processing duration corresponding to the network device performing the first operation for processing the AI model.

For another example, for the AI model deployed on the network device side, the network device sends the third information indicating the application scenario of the AI model or the functionality of the AI model. The device receiving the third information, such as the terminal, can determine, based on the third information, the processing duration corresponding to the network device performing the first operation for processing the AI model.

For example, for the AI model deployed on the terminal side, the network device receives the third information indicating the AI model, so that the network device can determine, based on the AI model indicated in the third information, the processing duration corresponding to the terminal performing the first operation for processing the AI model.

For another example, for the AI model deployed on the terminal side, the network device receives the third information indicating the application scenario of the AI model or the functionality of the AI model, so that the network device can determine, based on the third information, the processing duration corresponding to the terminal performing the first operation for processing the AI model.

It can be understood that the functionality of the AI model and the application scenario of the AI model can have the same meaning, which is used to distinguish the AI model for beam prediction, beam management, positioning, and other scenarios. The present disclosure does not limit the specific functionality or specific application scenario of the AI model.

In the present disclosure, the network device can determine the AI model and/or the application scenario of the AI model, so that the network device can call, based on the above information, the AI model deployed on the terminal after the processing duration, so as to perform corresponding processing, thereby improving the operating efficiency of the AI model.

In the communication method provided by embodiments of the present disclosure, the method may further include: performing the second operation based on the processing duration corresponding to the first operation, the second operation is configured to indicate to the network device to use an AI model manner or a non-AI model manner to process data, and an AI model corresponding to the AI model manner is an AI model after the first operation is performed by the network device.

In the communication method provided by embodiments of the present disclosure, the method further includes: receiving fourth information based on the processing duration corresponding to the first operation, the fourth information is configured to indicate the second operation, the second operation is configured to indicate to the network device to use the AI model manner or the non-AI model manner to process data, and the AI model corresponding to the AI model manner is the AI model after the first operation is performed by the network device.

The above solution will be described with more specific embodiments in the following.

In some implementations, the terminal may determine, based on a preset rule, to perform the second operation after a preset duration. It can be understood that the terminal may receive the information sent by the network device, which may indicate to the terminal to perform the first operation. The terminal determines, based on the preset rule, a time corresponding to the execution of the first operation, i.e., the preset time. The terminal determines to perform the second operation after the preset time.

The preset time may be the processing duration corresponding to the first operation described in each embodiment in FIGS. 2 to 9.

For example, the terminal receives a signaling sent by the network device, and the signaling may be any one or more of a Radio Resource Control (RRC) signaling, a Medium Access Control Control Element (MAC CE), and Downlink Control Information (DCI). Alternatively, the signaling may also be any other possible signaling, which is not limited in the present disclosure. The signaling indicates the first operation. The terminal determines the processing duration corresponding to the first operation, that is, the preset duration. After the preset duration, the terminal performs the second operation. It can be understood that the terminal can trigger the execution of the second operation by itself. For example, the first operation indicates to the terminal to activate an AI model for beam prediction. After the preset time, the terminal triggers the use of the AI model for beam prediction by itself to perform the corresponding beam prediction task.

For another example, the first operation indicates to the terminal to switch the AI model. It can be assumed that after processing data using AI model 1, the terminal can output a 10-bit result. The terminal feeds back the 10-bit result to the network device. It is assumed that after processing data using AI model 2, the terminal can output a 20-bit result. The terminal feeds back the 20-bit result to the network device. When the first operation indicates to the terminal to switch from AI model 1 to AI model 2, assuming that the terminal determines the time for the first operation to be t, the terminal feeds back the 10-bit result to the network device before time t. The terminal determines, based on the first operation, the processing duration corresponding to executing the first operation to be n. After t+n, the terminal can be considered to have completed the switching from AI model 1 to AI model 2, and the terminal feeds back the 20-bit result to the network device. Alternatively, for the time period corresponding to n, the terminal can be set not to send any information to the network device, or the terminal does not send any AI model output result to the network device.

It can be understood that the terminal and the network device in the above embodiments can be interchangeable. Specifically, the network device can determine, based on the preset rule, to perform the second operation after the preset duration. It can be understood that the network device can receive information sent by the terminal, which can indicate to the network device to perform the first operation. The network device determines, based on the preset rule, the time corresponding to the execution of the first operation, i.e., the preset time. The network device determines to perform the second operation after the preset time.

For example, the network device receives a signaling sent by the terminal, and the signaling may be any one or more of the RRC signaling, the MAC CE, and Uplink Control Information (UCI). Alternatively, the signaling may also be any other possible signaling, which is not limited in the present disclosure. The signaling indicates the first operation. The network device determines the processing duration corresponding to the first operation, that is, the preset duration. The network device performs the second operation after the preset duration. It can be understood that the network device can trigger the execution of the second operation by itself. For example, the first operation indicates to the network device to activate the AI model for beam prediction. After the preset time, the network device triggers the use of the AI model for beam prediction by itself to perform the corresponding beam prediction task.

For another example, the first operation indicates to the network device to switch the AI model. It can be assumed that after processing data using AI model 1, the network device can output a 10-bit result. The network device feeds back the 10-bit result to the terminal. It is assumed that after processing data using AI model 2, the network device can output a 20-bit result. The network device feeds back the 20-bit result to the terminal. When the first operation indicates to the network device to switch from AI model 1 to AI model 2, assuming that the network device determines the time for the first operation to be t, the network device feeds back the 10-bit result to the terminal before time t. The network device determines, based on the first operation, the processing duration corresponding to executing the first operation to be n. After t+n, the network device can be considered to have completed the switching from AI model 1 to AI model 2, and the network device feeds back the 20-bit result to the terminal. Alternatively, for the time period corresponding to n, the network device can be set not to send any information to the terminal, or the network device does not send any AI model output result to the terminal.

In some implementations, the terminal may determine the preset duration based on the preset rule. After the preset duration, the terminal receives information sent by the network device, which indicates the second operation. The terminal then performs the second operation. It can be understood that the terminal may receive the information sent by the network device, and the information indicates to the terminal to perform the first operation. Based on the preset rule, the terminal determines a time corresponding to performing the first operation, i.e., the preset time. The terminal determines that after the preset time, it receives the information sent by the network device indicating to the terminal to perform the second operation. The terminal then performs the second operation.

The preset time may be the processing duration corresponding to the first operation described in each embodiment in FIGS. 2 to 9.

For example, the terminal receives a first signaling sent by the network device indicating to the terminal to perform the first operation. The first signaling may be any one or more of the RRC signaling, the MAC CE, and the DCI. Alternatively, the first signaling may also be any other possible signaling, which is not limited in the present disclosure. The first signaling indicates the first operation. The terminal determines the processing duration corresponding to the first operation, i.e., the preset duration. After the preset duration, the terminal receives a second signaling sent by the network device indicating to the terminal to perform the second operation. The second signaling may be any one or more of the RRC signaling, the MAC CE, and the DCI. The terminal performs the second operation. It can be understood that the terminal may receive, after the preset duration, the second signaling sent by the network device to trigger the terminal to perform the second operation. For example, the first operation indicates to the terminal to activate an AI model for beam prediction. After the preset time, the terminal receives the second signaling, so as to trigger the terminal to use the AI model for beam prediction to perform the corresponding beam prediction task.

For another example, the first operation indicates to the terminal to switch the AI model. It can be assumed that after processing data using AI model 1, the terminal can output a 10-bit result. The terminal feeds back the 10-bit result to the network device. It is assumed that after processing data using AI model 2, the terminal can output a 20-bit result. The terminal feeds back the 20-bit result to the network device. When the first operation indicates to the terminal to switch from AI model 1 to AI model 2, assuming that the terminal determines the time for the first operation to be t, the terminal feeds back the 10-bit result to the network device before time t. The terminal determines, based on the first operation, the processing duration corresponding to executing the first operation to be n. After tin, the terminal can be considered to have completed the switching from AI model 1 to AI model 2. At time t′ after t+n, the terminal receives the second signaling sent by the network device indicating to the terminal to execute the second operation. If the terminal determines to execute the second operation, the terminal feeds back the 20-bit result to the network device. Alternatively, for the time period corresponding to n, and for a time period from t+n until time t′, the terminal can be set not to send any information to the network device, or the terminal does not send any AI model output result to the network device.

It can be understood that the terminal and the network device in the above embodiments can be interchangeable. Specifically, the network device may determine, based on the preset rule, to receive the signaling sent by the terminal after the preset duration to indicate to the network device to perform the second operation. It can be understood that the network device can receive a first signaling sent by the terminal, which can indicate to the network device to perform the first operation. The network device, based on the preset rule, determines a time corresponding to performing the first operation, i.e., the preset time. After the preset time, the network device receives a second signaling sent by the terminal to indicate to the network device to perform a second operation, and the network device performs the second operation.

For example, the network device receives a first signaling sent by the terminal indicating to the network device to perform the first operation. The first signaling may be any one or more of the RRC signaling, the MAC CE, and the UCI. Alternatively, the first signaling may also be any other possible signaling, which is not limited by the present disclosure. The first signaling indicates the first operation. The network device determines the processing duration corresponding to the first operation, i.e., the preset duration. After the preset duration, the network device receives a second signaling sent by the terminal indicating the network device to perform the second operation. The second signaling may be any one or more of the RRC signaling, the MAC CE, and the UCI. The network device performs the second operation. It can be understood that the network device may receive, after the preset duration, the second signaling sent by the terminal to trigger the network device to perform the second operation. For example, the first operation indicates to the network device to activate an AI model for beam prediction. After the preset time, the network device receives the second signaling, thereby triggering the network device to use the AI model for beam prediction to perform the corresponding beam prediction task.

For another example, the first operation indicates to the network device to switch the AI model. It can be assumed that after processing data using AI model 1, the network device can output a 10-bit result. The network device feeds back the 10-bit result to the terminal. It is assumed that after processing data using AI model 2, the network device can output a 20-bit result. The network device feeds back the 20-bit result to the terminal. When the first operation indicates to the network device to switch from AI model 1 to AI model 2, assuming that the network device determines the time for the first operation to be t, the network device feeds back the 10-bit result to the terminal before time t. The network device determines, based on the first operation, the processing duration corresponding to executing the first operation to be n. After t+n, the network device can be considered to have completed the switching from AI model 1 to AI model 2. At time t′ after t+n, the network device receives the second signaling sent by the terminal indicating to the network device to execute the second operation. If the network device determines to execute the second operation, the network device feeds back the 20-bit result to the terminal. Alternatively, for the time period corresponding to n, and for a time period from t+n until time t′, the network device can be set not to send any information to the terminal, or the network device does not send any AI model output result to the terminal.

It should be noted, those skilled in the art may understand that the various implementations/embodiments involved in the above-mentioned embodiments of the present disclosure may be used in conjunction with the aforementioned embodiments or may be used independently. Whether used alone or in conjunction with the aforementioned embodiments, the implementation principles are similar. In the implementations of the present disclosure, some implementations are described in terms of implementations used together. It shall be noted, those skilled in the art may understand that such examples are not limitations on the embodiments of the present disclosure.

Based on the same concept, the embodiments of the present disclosure also provide a communication device and a communication device.

It may be understood that the communication device and device provided in the embodiments of the present disclosure include hardware structures and/or software modules corresponding to the execution of each function in order to realize the above-mentioned functions. Combined with the units and algorithm steps of the various examples disclosed in the embodiments of the present disclosure, the embodiments of the present disclosure may be implemented in the form of hardware or a combination of hardware and computer software. Whether a function is executed in the form of hardware or computer software driving the hardware depends on the specific application and design constraints of the technical solution. Those skilled in the art may use different methods to implement the described functions for each specific application, but such implementation should not be considered to exceed the scope of the technical solution in the embodiments of the present disclosure.

FIG. 10 shows a schematic diagram of a communication device according to an example embodiment. Referring to FIG. 10, the communication device 200 is configured in a terminal and includes: a processing module 201, configured to determine a processing duration corresponding to a first operation related to AI model processing.

In the present disclosure, a processing duration corresponding to a first operation related to AI model processing is determined, thereby ensuring that the terminal and the network device are time-aligned based on the processing duration. This allows the network device or the terminal to call an AI model deployed on the peer side after the processing duration to perform corresponding processing, thereby improving the operating efficiency of the AI model.

In some implementations, the first operation includes at least one of: an operation for activating an AI model; an operation for switching the AI model; or an operation for deactivating the AI model.

The present disclosure provides a variety of first operations related to the AI model processing to determine the processing duration corresponding to the operation, thereby ensuring that the terminal and the network device are time-aligned based on the processing duration. This allows the network device or the terminal to call an AI model deployed on the peer side after the processing duration to perform corresponding processing, thereby improving the operating efficiency of the AI model.

In some implementations, different first operations correspond to different processing durations.

The present disclosure determines different processing durations for different first operations related to the AI model processing, thereby ensuring that the terminal and network device can be time-aligned based on different processing durations for different operations. This allows the network device or the terminal to call an AI model deployed on the peer side after the processing duration to perform corresponding processing, thereby improving the operating efficiency of the AI model.

In some implementations, a processing duration corresponding to the operation for activating the AI model is greater than or equal to a processing duration corresponding to the operation for switching the AI model; and/or, a processing duration corresponding to the operation for deactivating the AI model is less than or equal to the processing duration corresponding to the operation for switching the AI model.

The present disclosure provides specific processing duration relationships for different operations related to the AI model processing, thereby ensuring that the terminal and network device can be time-aligned based on different processing durations for different operations. This allows the network device or the terminal to call an AI model deployed on the peer side after the processing duration to perform corresponding processing, thereby improving the operating efficiency of the AI model.

In some implementations, the processing duration corresponding to the first operation varies depending on a deployment mode of the AI model.

The present disclosure determines different processing durations for different AI model deployment modes, thereby ensuring that the terminal and network device can be time-aligned based on different processing durations for different operations. This allows the network device or the terminal to call an AI model deployed on the peer side after the processing duration to perform corresponding processing, thereby improving the operating efficiency of the AI model.

In some implementations, the AI model is deployed on the terminal or the network device, and the processing duration corresponding to the first operation is a first processing duration; and the AI model is deployed on the terminal and the network device, and the processing duration corresponding to the first operation is a second processing duration; and processing durations corresponding to first operations being different includes: the first processing duration being less than or equal to the second processing duration.

The present disclosure provides specific processing duration relationships for different AI model deployment modes, thereby ensuring that the terminal and network device can be time-aligned based on different processing durations for different operations. This allows the network device or the terminal to call an AI model deployed on the peer side after the processing duration to perform corresponding processing, thereby improving the operating efficiency of the AI model.

In some implementations, the processing duration corresponding to the first operation varies depending on an application scenario of the AI model.

The present disclosure determines different processing durations for different application scenarios of the AI model, thereby ensuring that the terminal and network device can be time-aligned based on different processing durations for different operations. This allows the network device or the terminal to call an AI model deployed on the peer side after the processing duration to perform corresponding processing, thereby improving the operating efficiency of the AI model.

In some implementations, the processing duration corresponding to the first operation varies depending on a storage space occupied by the AI model; or the processing duration corresponding to the first operation varies depending on a complexity of the AI model.

The present disclosure can determine different processing durations for the different storage space occupied by the AI models or different complexities of the AI models, thereby ensuring that the terminal and network device can be time-aligned based on different processing durations for different operations. This allows the network device or the terminal to call an AI model deployed on the peer side after the processing duration to perform corresponding processing, thereby improving the operating efficiency of the AI model.

In some implementations, the processing duration corresponding to the first operation varies depending on a capability corresponding to the terminal.

The present disclosure can determine different processing durations for different terminal capabilities, thereby ensuring that the terminal and network device can be time-aligned based on different processing durations for different operations. This allows the network device or the terminal to call an AI model deployed on the peer side after the processing duration to perform corresponding processing, thereby improving the operating efficiency of the AI model.

In some implementations, the communication device 200 further includes: a sending module 202, configured to send first information, and the first information is configured to indicate a capability corresponding to the terminal and/or a processing duration corresponding to a first operation supported by the capability.

In the present disclosure, the terminal can report its own capability and/or the processing duration corresponding to the first operation corresponding to the capability, so that the network device can call, based on the information reported by the terminal, the AI model deployed on the terminal after the processing duration, so as to perform corresponding processing, thereby improving the operating efficiency of the AI model.

In some implementations, the processing duration corresponding to the first operation varies depending on a terminal operation status corresponding to the terminal.

The present disclosure can determine different processing durations for different terminal statuses, thereby ensuring that the terminal and network device can be time-aligned based on different processing durations for different operations. This allows the network device or the terminal to call an AI model deployed on the peer side after the processing duration to perform corresponding processing, thereby improving the operating efficiency of the AI model.

In some implementations, the communication device 200 further includes: a sending module 202, configured to send second information, and the second information is configured to indicate the terminal operation status corresponding to the terminal and/or a processing duration corresponding to a first operation supported by the terminal operation status.

In the present disclosure, the terminal can report the terminal status and/or the processing duration corresponding to the first operation supported by the terminal status, so that the network device can call, based on the information reported by the terminal, the AI model deployed on the terminal after the processing duration, so as to perform corresponding processing, thereby improving the operating efficiency of the AI model.

In some implementations, the processing module 201 is further configured to determine third information, and the third information is configured to indicate an AI model deployed on the terminal and/or a network device, and/or to indicate an application scenario of the AI model.

In the present disclosure, the terminal can determine the AI model and/or the application scenario of the AI model, so that the terminal can call, based on the above information, the AI model deployed on the network device after the processing duration, so as to perform the corresponding processing, thereby improving the operating efficiency of the AI model.

In some implementations, the processing module 201 is further configured to perform a second operation based on the processing duration corresponding to the first operation, the second operation is configured to indicate to the terminal to use an AI model manner or a non-AI model manner to process data, and an AI model corresponding to the AI model manner is an AI model after the first operation is performed by the terminal.

In some implementations, the communication device 200 further includes: a receiving module 203, configured to receive fourth information based on the processing duration corresponding to the first operation, the fourth information is configured to indicate the second operation, the second operation is configured to indicate to the terminal to use an AI model manner or a non-AI model manner to process data, and an AI model corresponding to the AI model manner is an AI model after the first operation is performed by the terminal.

FIG. 11 shows a schematic diagram of another communication device according to an example embodiment. Referring to FIG. 11, the communication device 300 is configured in a network device and includes a processing module 301, configured to determine a processing duration corresponding to a first operation related to AI model processing.

In the present disclosure, a processing duration corresponding to a first operation related to AI model processing is determined, thereby ensuring that the terminal and the network device are time-aligned based on the processing duration. This allows the network device or the terminal to call an AI model deployed on the peer side after the processing duration to perform corresponding processing, thereby improving the operating efficiency of the AI model.

In some implementations, the first operation includes at least one of: an operation for activating an AI model; an operation for switching the AI model; or an operation for deactivating the AI model.

The present disclosure provides a variety of first operations related to the AI model processing to determine the processing duration corresponding to the operation, thereby ensuring that the terminal and the network device are time-aligned based on the processing duration. This allows the network device or the terminal to call an AI model deployed on the peer side after the processing duration to perform corresponding processing, thereby improving the operating efficiency of the AI model.

In some implementations, different first operations correspond to different processing durations.

The present disclosure determines different processing durations for different first operations related to the AI model processing, thereby ensuring that the terminal and network device can be time-aligned based on different processing durations for different operations. This allows the network device or the terminal to call an AI model deployed on the peer side after the processing duration to perform corresponding processing, thereby improving the operating efficiency of the AI model.

In some implementations, a processing duration corresponding to the operation for activating the AI model is greater than or equal to a processing duration corresponding to the operation for switching the AI model; and/or, a processing duration corresponding to the operation for deactivating the AI model is less than or equal to the processing duration corresponding to the operation for switching the AI model.

The present disclosure provides specific processing duration relationships for different first operations related to the AI model processing, thereby ensuring that the terminal and network device can be time-aligned based on different processing durations for different operations. This allows the network device or the terminal to call an AI model deployed on the peer side after the processing duration to perform corresponding processing, thereby improving the operating efficiency of the AI model.

In some implementations, the processing duration corresponding to the first operation varies depending on a deployment mode of the AI model.

The present disclosure determines different processing durations for different AI model deployment modes, thereby ensuring that the terminal and network device can be time-aligned based on different processing durations for different operations. This allows the network device or the terminal to call an AI model deployed on the peer side after the processing duration to perform corresponding processing, thereby improving the operating efficiency of the AI model.

In some implementations, the AI model is deployed on the terminal or the network device, and the processing duration corresponding to the first operation is a first processing duration; and the AI model is deployed on the terminal and the network device, and the processing duration corresponding to the first operation is a second processing duration; and processing durations corresponding to first operations being different includes: the first processing duration being less than or equal to the second processing duration.

The present disclosure provides specific processing duration relationships for different AI model deployment modes, thereby ensuring that the terminal and network device can be time-aligned based on different processing durations for different operations. This allows the network device or the terminal to call an AI model deployed on the peer side after the processing duration to perform corresponding processing, thereby improving the operating efficiency of the AI model.

In some implementations, the processing duration corresponding to the first operation varies depending on an application scenario of the AI model.

The present disclosure determines different processing durations for different application scenarios of the AI model, thereby ensuring that the terminal and network device can be time-aligned based on different processing durations for different operations. This allows the network device or the terminal to call an AI model deployed on the peer side after the processing duration to perform corresponding processing, thereby improving the operating efficiency of the AI model.

In some implementations, the processing duration corresponding to the first operation varies depending on a storage space occupied by the AI model; or the processing duration corresponding to the first operation varies depending on a complexity of the AI model.

The present disclosure can determine different processing durations for the different storage space occupied by the AI models or different complexities of the AI models, thereby ensuring that the terminal and network device can be time-aligned based on different processing durations for different operations. This allows the network device or the terminal to call an AI model deployed on the peer side after the processing duration to perform corresponding processing, thereby improving the operating efficiency of the AI model.

In some implementations, the processing duration corresponding to the first operation varies depending on a capability corresponding to the terminal.

The present disclosure can determine different processing durations for different terminal capabilities, thereby ensuring that the terminal and network device can be time-aligned based on different processing durations for different operations. This allows the network device or the terminal to call an AI model deployed on the peer side after the processing duration to perform corresponding processing, thereby improving the operating efficiency of the AI model.

In some implementations, the communication device 300 further includes: a receiving module 302, configured to receive first information, and the first information is configured to indicate a capability corresponding to the terminal and/or a processing duration corresponding to a first operation supported by the capability.

In the present disclosure, the network device can receive the terminal's capability and/or the processing duration corresponding to the first operation corresponding to the capability that are reported by the terminal, so that the network device can call, based on the information reported by the terminal, the AI model deployed on the terminal after the processing duration, so as to perform corresponding processing, thereby improving the operating efficiency of the AI model.

In some implementations, the processing duration corresponding to the first operation varies depending on a terminal operation status corresponding to the terminal.

The present disclosure can determine different processing durations for different terminal statuses, thereby ensuring that the terminal and network device can be time-aligned based on different processing durations for different operations. This allows the network device or the terminal to call an AI model deployed on the peer side after the processing duration to perform corresponding processing, thereby improving the operating efficiency of the AI model.

In some implementations, the communication device 300 further includes: a receiving module 302, configured to receive second information, and the second information is configured to indicate a terminal operation status corresponding to the terminal and/or a processing duration corresponding to a first operation supported by the terminal operation status.

In the present disclosure, the network device can receive the terminal status and/or the processing duration corresponding to the first operation supported by the terminal status which are reported by the terminal, so that the network device can call, based on the information reported by the terminal, the AI model deployed on the terminal after the processing duration, so as to perform corresponding processing, thereby improving the operating efficiency of the AI model.

In some implementations, the processing module 301 is further configured to determine third information, and the third information is configured to indicate an AI model deployed on the terminal and/or a network device, and/or to indicate an application scenario of the AI model.

In the present disclosure, the network device can determine the AI model and/or the application scenario of the AI model, so that the network device can call, based on the above information, the AI model deployed on the terminal after the processing duration, so as to perform corresponding processing, thereby improving the operating efficiency of the AI model.

In some implementations, the processing module 301 is further configured to: perform a second operation based on the processing duration corresponding to the first operation, the second operation is configured to indicate to the network device to use an AI model manner or a non-AI model manner to process data, and an AI model corresponding to the AI model manner is an AI model after the first operation is performed by the network device.

In some implementations, the communication device 300 further includes: a receiving module 302, configured to receive fourth information based on the processing duration corresponding to the first operation, the fourth information is configured to indicate the second operation, the second operation is configured to indicate to the network device to use an AI model manner or a non-AI model manner to process data, and an AI model corresponding to the AI model manner is an AI model after the first operation is performed by the network device.

It can be understood that the communication device 300 may further include a sending module. It should be understood that the communication device 200 and the communication device 300 are not limited to various modules shown in the figures, and may further include other corresponding modules according to actual conditions, which is not limited in the present disclosure.

Regarding the apparatus in the above embodiment(s), the specific manner in which each module performs the operation has been described in detail in the method embodiments, and will not be explained in detail here.

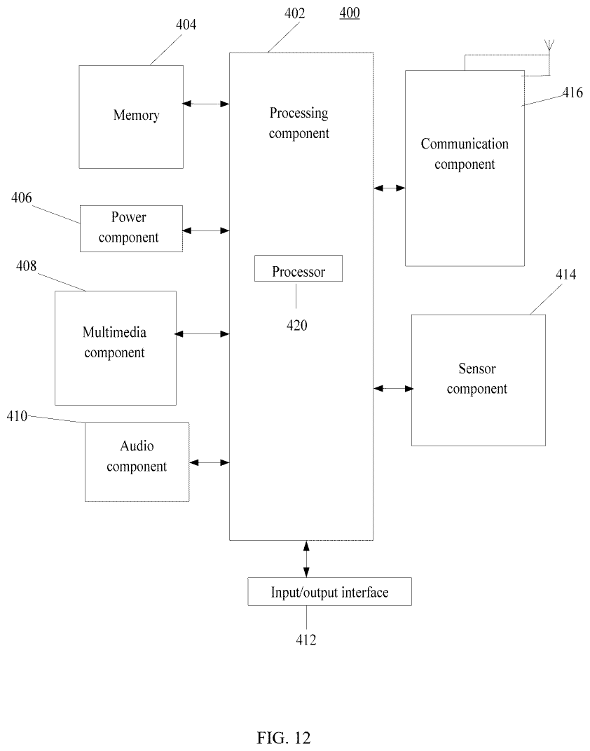

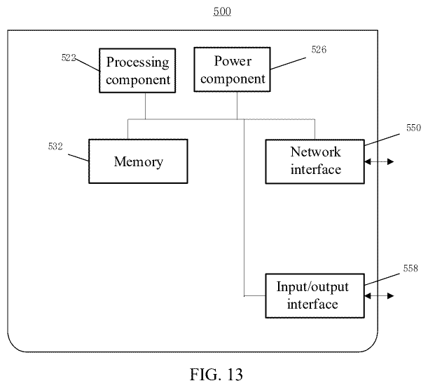

FIG. 12 shows a schematic diagram of a communication device according to an example embodiment. For example, the communication device 400 may be any terminal such as a mobile phone, a computer, a digital broadcast terminal, a messaging device, a game console, a tablet device, a medical device, a fitness device, a personal digital assistant, etc.

Referring to FIG. 12, the communication device 400 may include one or more of the following components: a processing component 402, a memory 404, a power component 406, a multimedia component 408, an audio component 410, an input/output (I/O) interface 412, a sensor component 414, and a communication component 416.

The processing component 402 generally controls the overall operation of the communication device 400, such as operations associated with display, phone calls, data communications, camera operations, and recording operations. The processing component 402 may include one or more processors 420 to execute instructions to complete all or some of the steps of the above-mentioned method(s). In addition, the processing component 402 may include one or more modules to facilitate the interaction between the processing component 402 and other components. For example, the processing component 402 may include a multimedia module to facilitate the interaction between the multimedia component 408 and the processing component 402.

The memory 404 is configured to store various types of data to support the operation of the communication device 400. Examples of such data include instructions for any application or method operating on the communication device 400, contact data, phone book data, messages, pictures, videos, etc. The memory 404 may be implemented by any type of volatile or nonvolatile memory device or a combination thereof, such as Static Random Access Memory (SRAM), Electrically Erasable Programmable Read-Only Memory (EEPROM), Erasable Programmable Read-Only Memory (EPROM), Programmable Read-Only Memory (PROM), Read-Only Memory (ROM), magnetic memory, flash memory, magnetic disk, or optical disk.

The power component 406 provides power to various components of the communication device 400. The power component 406 may include a power management system, one or more power supplies, and other components associated with generating, managing, and distributing power for the communication device 400.

The multimedia component 408 includes a screen that provides an output interface between the communication device 400 and the user. In some implementations, the screen may include a Liquid Crystal Display (LCD) and a Touch Panel (TP). If the screen includes a touch panel, the screen may be implemented as a touch screen to receive input signals from the user. The touch panel includes one or more touch sensors to sense touch, slide, and gestures on the touch panel. The touch sensor may not only sense the boundaries of the touch or slide action, but also detect the duration and pressure associated with the touch or slide operation. In some implementations, the multimedia component 408 includes a front camera and/or a rear camera. When the communication device 400 is in an operating mode, such as a shooting mode or a video mode, the front camera and/or the rear camera may receive external multimedia data. Each of the front camera and the rear camera may be a fixed optical lens system or have a focal length and optical zooming capability.

The audio component 410 is configured to output and/or input audio signals. For example, the audio component 410 includes a microphone (MIC). The microphone (MIC) is configured to receive external audio signals when the communication device 400 is in an operating mode, such as a call mode, a recording mode, and a voice recognition mode. The received audio signal may be further stored in the memory 404 or sent via the communication component 416. In some implementations, the audio component 410 also includes a speaker for outputting audio signals.

The I/O interface 412 provides an interface between the processing component 402 and the peripheral interface module, which may be a keyboard, a click wheel, a button, etc. These buttons may include, but are not limited to: a home button, a volume button, a start button, and a lock button.

The sensor component 414 includes one or more sensors for providing various aspects of status evaluation for the communication device 400. For example, the sensor component 414 may detect the on/off state of the communication device 400, the relative positioning of the components, such as the display and the keypad of the communication device 400. The sensor component 414 may also detect the position change of the communication device 400 or a component of the communication device 400, the presence or absence of contact between the user and the communication device 400, the orientation or acceleration/deceleration of the communication device 400, and the temperature change of the communication device 400. The sensor component 414 may include a proximity sensor, which is configured to detect the presence of a nearby object without any physical contact. The sensor component 414 may also include a light sensor, such as a CMOS or CCD image sensor, for use in imaging applications. In some implementations, the sensor component 414 may also include an accelerometer, a gyroscope, a magnetic sensor, a pressure sensor, or a temperature sensor.

The communication component 416 is configured to facilitate wired or wireless communication between the communication device 400 and other devices. The communication device 400 may access a wireless network based on a communication standard, such as WiFi, 2G or 3G, or a combination thereof. In an example embodiment, the communication component 416 receives a broadcast signal or broadcast-related information from an external broadcast management system via a broadcast channel. In an example embodiment, the communication component 416 also includes a Near Field Communication (NFC) module to facilitate short-range communication. For example, the NFC module may be implemented based on Radio Frequency Identification (RFID) technology, Infrared Data Association (IrDA) technology, Wltra-WideBand (UWB) technology, Bluetooth (BT) technology, and other technologies.

In an example embodiment, the communication device 400 may be implemented by one or more Application-Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, microcontrollers, microprocessors, or other electronic components to perform the above method(s).

In an example embodiment, a non-transitory computer-readable storage medium including instructions is also provided, such as a memory 404 including instructions. The above instructions may be executed by a processor 420 of the communication device 400 to complete the above method(s). For example, the non-transitory computer-readable storage medium may be a ROM, a Random Access Memory (RAM), a CD-ROM, a tape, a floppy disk, and an optical data storage device, etc.

FIG. 13 shows a schematic diagram of another communication device according to an example embodiment. For example, the communication device 500 may be provided as a base station, or a server. Referring to FIG. 13, the communication device 500 includes a processing component 522, which further includes one or more processors, and a memory resource represented by a memory 532 for storing instructions executable by the processing component 522, such as an application. The application stored in the memory 532 may include one or more modules each corresponding to a set of instructions. In addition, the processing component 522 is configured to execute instructions to perform the above method(s).

The communication device 500 may also include: a power component 526 configured to perform power management of the communication device 500; a wired or wireless network interface 550 configured to connect the communication device 500 to the network; and an input/output (I/O) interface 558. The communication device 500 may operate based on an operation system stored in the memory 532, such as Windows Server™, Mac OS X™, Unix™ Linux™ FreeBSD™ or the like.

In some implementations, the present disclosure further provides a communication system including a terminal and a network device. The terminal can execute the methods described in FIGS. 2 to 5. The network device can execute the methods described in FIGS. 6 to 9. For details, please refer to the description of the above embodiments, which will not be repeated in the present disclosure.

In the present disclosure, the processing duration corresponding to the operation related to the AI model processing is determined, thereby ensuring that the terminal and the network device are time-aligned based on the processing duration. This allows the network device or the terminal to call the AI model deployed on the peer side to perform corresponding processing after the processing duration, thereby improving the operating efficiency of the AI model.

The present disclosure provides a communication method, a communication device and a storage medium.

According to a first aspect of embodiments of the present disclosure, there is provided a communication method, which is performed by a terminal. The method includes: determining a processing duration corresponding to a first operation related to AI model processing.

In some implementations, the first operation includes at least one of: an operation for activating an AI model; an operation for switching the AI model; or an operation for deactivating the AI model.

In some implementations, different first operations correspond to different processing durations.

In some implementations, a processing duration corresponding to the operation for activating the AI model is greater than or equal to a processing duration corresponding to the operation for switching the AI model; and/or, a processing duration corresponding to the operation for deactivating the AI model is less than or equal to the processing duration corresponding to the operation for switching the AI model.

In some implementations, the processing duration corresponding to the first operation varies depending on a deployment mode of the AI model.

In some implementations, the AI model is deployed on the terminal or a network device, and a processing duration corresponding to the first operation is a first processing duration; and the AI model is deployed on the terminal and the network device, and the processing duration corresponding to the first operation is a second processing duration; and processing durations corresponding to first operations being different includes: the first processing duration being less than or equal to the second processing duration.

In some implementations, the processing duration corresponding to the first operation varies depending on an application scenario of the AI model.

In some implementations, the processing duration corresponding to the first operation varies depending on a storage space occupied by the AI model; or the processing duration corresponding to the first operation varies depending on a complexity of the AI model.

In some implementations, the processing duration corresponding to the first operation varies depending on a capability corresponding to the terminal.

In some implementations, the method further includes: sending first information, wherein the first information is configured to indicate the capability corresponding to the terminal and/or a processing duration corresponding to a first operation supported by the capability.

In some implementations, the processing duration corresponding to the first operation varies depending on a terminal operation status corresponding to the terminal.

In some implementations, the method further includes: sending second information, wherein the second information is configured to indicate the terminal operation status corresponding to the terminal and/or a processing duration corresponding to a first operation supported by the terminal operation status.

In some implementations, the method further includes: determining third information, wherein the third information is configured to indicate an AI model deployed on the terminal and/or the network device, and/or to indicate an application scenario of the AI model.

In some implementations, the method further includes: performing a second operation based on the processing duration corresponding to the first operation, wherein the second operation is configured to indicate to the terminal to use an AI model manner or a non-AI model manner to process data, and an AI model corresponding to the AI model manner is an AI model after the first operation is performed by the terminal.

In some implementations, the method further includes: receiving fourth information based on the processing duration corresponding to the first operation, wherein the fourth information is configured to indicate the second operation, the second operation is configured to indicate to the terminal to use an AI model manner or a non-AI model manner to process data, and an AI model corresponding to the AI model manner is an AI model after the first operation is performed by the terminal.

According to a second aspect of embodiments of the present disclosure, there is provided a communication method, which is performed by a network device. The method includes: determining a processing duration corresponding to a first operation related to AI model processing.

In some implementations, the first operation includes at least one of: an operation for activating an AI model; an operation for switching the AI model; or an operation for deactivating the AI model.

In some implementations, different first operations correspond to different processing durations.

In some implementations, a processing duration corresponding to the operation for activating the AI model is greater than or equal to a processing duration corresponding to the operation for switching the AI model; and/or, a processing duration corresponding to the operation for deactivating the AI model is less than or equal to the processing duration corresponding to the operation for switching the AI model.

In some implementations, the processing duration corresponding to the first operation varies depending on a deployment mode of the AI model.

In some implementations, the AI model is deployed on a terminal or the network device, and the processing duration corresponding to the first operation is a first processing duration; and the AI model is deployed on the terminal and the network device, and the processing duration corresponding to the first operation is a second processing duration; and processing durations corresponding to first operations being different includes: the first processing duration being less than or equal to the second processing duration.

In some implementations, the processing duration corresponding to the first operation varies depending on an application scenario of the AI model.

In some implementations, the processing duration corresponding to the first operation varies depending on a storage space occupied by the AI model; or the processing duration corresponding to the first operation varies depending on a complexity of the AI model.

In some implementations, the processing duration corresponding to the first operation varies depending on a capability corresponding to the terminal.

In some implementations, the method further includes: receiving first information, wherein the first information is configured to indicate the capability corresponding to the terminal and/or a processing duration corresponding to a first operation supported by the capability.

In some implementations, the processing duration corresponding to the first operation varies depending on a terminal operation status corresponding to the terminal.

In some implementations, the method further includes: receiving second information, wherein the second information is configured to indicate the terminal operation status corresponding to the terminal and/or a processing duration corresponding to a first operation supported by the terminal operation status.

In some implementations, the method further includes: determining third information, wherein the third information is configured to indicate an AI model deployed on the terminal and/or a network device, and/or to indicate an application scenario of the AI model.

In some implementations, the method further includes: performing a second operation based on the processing duration corresponding to the first operation, wherein the second operation is configured to indicate to the network device to use an AI model manner or a non-AI model manner to process data, and an AI model corresponding to the AI model manner is an AI model after the first operation is performed by the network device.

In some implementations, the method further includes: receiving fourth information based on the processing duration corresponding to the first operation, wherein the fourth information is configured to indicate the second operation, the second operation is configured to indicate to the network device to use an AI model manner or a non-AI model manner to process data, and an AI model corresponding to the AI model manner is an AI model after the first operation is performed by the network device.

According to a third aspect of embodiments of the present disclosure, there is provided a communication device, which is configured in a terminal. The communication device includes: a processing module configured to determine a processing duration corresponding to a first operation related to AI model processing.

In some implementations, the first operation includes at least one of: an operation for activating an AI model; an operation for switching the AI model; or an operation for deactivating the AI model.

In some implementations, different first operations correspond to different processing durations.

In some implementations, a processing duration corresponding to the operation for activating the AI model is greater than or equal to a processing duration corresponding to the operation for switching the AI model; and/or, a processing duration corresponding to the operation for deactivating the AI model is less than or equal to the processing duration corresponding to the operation for switching the AI model.

In some implementations, the processing duration corresponding to the first operation varies depending on a deployment mode of the AI model.

In some implementations, the AI model is deployed on the terminal or a network device, and the processing duration corresponding to the first operation is a first processing duration; and the AI model is deployed on the terminal and the network device, and the processing duration corresponding to the first operation is a second processing duration; and processing durations corresponding to first operations being different includes: the first processing duration being less than or equal to the second processing duration.

In some implementations, the processing duration corresponding to the first operation varies depending on an application scenario of the AI model.

In some implementations, the processing duration corresponding to the first operation varies depending on a storage space occupied by the AI model; or the processing duration corresponding to the first operation varies depending on a complexity of the AI model.

In some implementations, the processing duration corresponding to the first operation varies depending on a capability corresponding to the terminal,

In some implementations, the communication device further includes: a sending module configured to send first information, wherein the first information is configured to indicate the capability corresponding to the terminal and/or a processing duration corresponding to a first operation supported by the capability.

In some implementations, the processing duration corresponding to the first operation varies depending on a terminal operation status corresponding to the terminal.

In some implementations, the communication device further includes: a sending module configured to send second information, wherein the second information is configured to indicate the terminal operation status corresponding to the terminal and/or a processing duration corresponding to a first operation supported by the terminal operation status.

In some implementations, the processing module is further configured to determine third information, wherein the third information is configured to indicate an AI model deployed on the terminal and/or the network device, and/or to indicate an application scenario of the AI model.

In some implementations, the processing module is further configured to: perform a second operation based on the processing duration corresponding to the first operation, wherein the second operation is configured to indicate to the terminal to use an AI model manner or a non-AI model manner to process data, and an AI model corresponding to the AI model manner is an AI model after the first operation is performed by the terminal.

In some implementations, the communication device further includes: a receiving module configured to receive fourth information based on the processing duration corresponding to the first operation, wherein the fourth information is configured to indicate the second operation, the second operation is configured to indicate to the terminal to use an AI model manner or a non-AI model manner to process data, and an AI model corresponding to the AI model manner is an AI model after the first operation is performed by the terminal.

According to a fourth aspect of embodiments of the present disclosure, there is provided a communication device, which is configured in a network device. The communication device includes: a processing module configured to determine a processing duration corresponding to a first operation related to AI model processing.

In some implementations, the first operation includes at least one of: an operation for activating an AI model; an operation for switching the AI model; or an operation for deactivating the AI model.

In some implementations, different first operations correspond to different processing durations.

In some implementations, a processing duration corresponding to the operation for activating the AI model is greater than or equal to a processing duration corresponding to the operation for switching the AI model; and/or, a processing duration corresponding to the operation for deactivating the AI model is less than or equal to the processing duration corresponding to the operation for switching the AI model.

In some implementations, the processing duration corresponding to the first operation varies depending on a deployment mode of the AI model.

In some implementations, the AI model is deployed on a terminal or the network device, and the processing duration corresponding to the first operation is a first processing duration; and the AI model is deployed on the terminal and the network device, and the processing duration corresponding to the first operation is a second processing duration; and processing durations corresponding to first operations being different includes: the first processing duration being less than or equal to the second processing duration.

In some implementations, the processing duration corresponding to the first operation varies depending on an application scenario of the AI model.

In some implementations, the processing duration corresponding to the first operation varies depending on a storage space occupied by the AI model; or the processing duration corresponding to the first operation varies depending on a complexity of the AI model.

In some implementations, the processing duration corresponding to the first operation varies depending on a capability corresponding to the terminal.

In some implementations, the communication device further includes: a receiving module configured to receive first information, wherein the first information is configured to indicate the capability corresponding to the terminal and/or a processing duration corresponding to a first operation supported by the capability.

In some implementations, the processing duration corresponding to the first operation varies depending on a terminal operation status corresponding to the terminal.

In some implementations, the communication device further includes: a receiving module configured to receive second information, wherein the second information is configured to indicate the terminal operation status corresponding to the terminal and/or a processing duration corresponding to a first operation supported by the terminal operation status.

In some implementations, the processing module is further configured to determine third information, wherein the third information is configured to indicate an AI model deployed on the terminal and/or the network device, and/or to indicate an application scenario of the AI model.

In some implementations, the processing module is further configured to: perform a second operation based on the processing duration corresponding to the first operation, wherein the second operation is configured to indicate to the network device to use an AI model manner or a non-AI model manner to process data, and an AI model corresponding to the AI model manner is an AI model after the first operation is performed by the network device.

In some implementations, the communication device further includes: a receiving module configured to receive fourth information based on the processing duration corresponding to the first operation, wherein the fourth information is configured to indicate the second operation, the second operation is configured to indicate to the network device to use an AI model manner or a non-AI model manner to process data, and an AI model corresponding to the AI model manner is an AI model after the first operation is performed by the network device.

According to a fifth aspect of embodiments of the present disclosure, there is provided a communication device, including: a processor; and a memory configured to store instructions executable by the processor. The processor is configured to perform the first aspect and any one of the methods in the first aspect.

According to a sixth aspect of embodiments of the present disclosure, there is provided a communication device, including: a processor; and a memory configured to store instructions executable by the processor. The processor is configured to perform the second aspect and any one of the methods in the second aspect.

According to a seventh aspect of embodiments of the present disclosure, there is provided a communication system, which includes: a terminal, configured to perform the first aspect and any one of the methods in the first aspect; and a network device, configured to perform the second aspect and any one of the methods in the second aspect.

According to an eighth aspect of embodiments of the present disclosure, there is provided a non-transitory computer-readable storage medium. When instructions in the storage medium are executed by a processor of a terminal, the terminal is enabled to perform the first aspect and any one of the methods in the first aspect.

According to a ninth aspect of embodiments of the present disclosure, there is provided a non-transitory computer-readable storage medium. When instructions in the storage medium are executed by a processor of a network device, the network device is enabled to perform the second aspect and any one of the methods in the second aspect.

It can be further understood that in the present disclosure, “a plurality of” refers to two or more, and other quantifiers are similar. “And/or” describes the association relationship of the associated objects, indicating that there may be three relationships. For example, A and/or B may represent: A exists alone; A and B exist at the same time; and B exists alone. The character “/” generally indicates that the objects associated with each other are in an “or” relationship. The singular forms “a”, “the”, and “said” are also intended to include the plural forms, unless the context clearly indicates otherwise.

It is further understood that the terms “first”, “second”, etc. are used to describe various information, but these information should not be limited to these terms. These terms are only used to distinguish the same type of information from each other and do not indicate a specific order or degree of importance. In fact, the expressions “first”, “second”, etc. may be used interchangeably. For example, without departing from the scope of the present disclosure, the first information may also be referred to as the second information, and similarly, the second information may also be referred to as the first information.

It is further understood that the meaning of the words “in response to” and “if” involved in the present disclosure depends on the context and the actual application scenario. For example, the word “in response to” used herein may be interpreted as “at” or “when” or “if” or “in case”.

It is further understood that although the operations are described in a specific order in the drawings in the embodiments of the present disclosure, this should not be understood as requiring the operations to be performed in the specific order as shown or in a serial order, or requiring the execution of all the operations shown to obtain the desired results. In certain environments, multitasking and parallel processing may be advantageous.

Other embodiments of the present disclosure will be readily apparent to those skilled in the art after considering the specification and practicing the content disclosed herein. The present application is intended to cover any variation, use, or adaptation of the present disclosure that follows the general principles of the present disclosure and includes common knowledge or conventional techniques in the art that are not disclosed in the present disclosure.

It should be understood that the present disclosure is not limited to the precise structures described above and shown in the accompanying drawings, and that various modifications and changes may be made without departing from the scope thereof. The scope of the present disclosure is limited only by the scope of the appended claims.

1. A communication method, performed by a terminal, and comprising:
determining a processing duration corresponding to a first operation related to Artificial Intelligence (AI) model processing.

2. The method according to claim 1, wherein the first operation comprises at least one of:
an operation for activating an AI model;
an operation for switching the AI model; or
an operation for deactivating the AI model.

3. The method according to claim 2, wherein different first operations correspond to different processing durations.

4. The method according to claim 3, wherein a processing duration corresponding to the operation for activating the AI model is greater than or equal to a processing duration corresponding to the operation for switching the AI model; and/or,
a processing duration corresponding to the operation for deactivating the AI model is less than or equal to the processing duration corresponding to the operation for switching the AI model.

5. The method according to claim 1, wherein the processing duration corresponding to the first operation varies depending on a deployment mode of an AI model.

6. The method according to claim 5, wherein the AI model is deployed on the terminal or a network device, and the processing duration corresponding to the first operation is a first processing duration; or
the AI model is deployed on the terminal and the network device, and the processing duration corresponding to the first operation is a second processing duration; and
the first processing duration is less than or equal to the second processing duration.

7. The method according to claim 1, wherein the processing duration corresponding to the first operation varies depending on an application scenario of an AI model.

8. The method according to claim 1, wherein the processing duration corresponding to the first operation varies depending on a storage space occupied by an AI model; or
the processing duration corresponding to the first operation varies depending on a complexity of the AI model.

9. The method according to claim 1, wherein the processing duration corresponding to the first operation varies depending on a capability corresponding to the terminal.

10. The method according to claim 9, further comprising:
sending first information, wherein the first information is configured to indicate at least one of the capability corresponding to the terminal and/or a processing duration corresponding to a first operation supported by the capability.

11. The method according to claim 1, wherein the processing duration corresponding to the first operation varies depending on a terminal operation status corresponding to the terminal.

12. The method according to claim 11, further comprising:
sending second information, wherein the second information is configured to indicate at least one of the terminal operation status corresponding to the terminal or a processing duration corresponding to a first operation supported by the terminal operation status.

13. The method according to claim 1, further comprising:
determining third information, wherein the third information is configured to indicate at least one of:
an AI model deployed on at least one of the terminal or a network device; or
an application scenario of the AI model.

14. A communication method, performed by a network device, and comprising:
determining a processing duration corresponding to a first operation related to Artificial Intelligence (AI) model processing.

15.-21. (canceled)

22. The method according to claim 14, wherein the processing duration corresponding to the first operation varies depending on a capability corresponding to a terminal; and
the method further comprises:
receiving first information, wherein the first information is configured to indicate at least one of the capability corresponding to the terminal or a processing duration corresponding to a first operation supported by the capability.

23. (canceled)

24. The method according to claim 14, wherein the processing duration corresponding to the first operation varies depending on a terminal operation status corresponding to a terminal; and
the method further comprises:
receiving second information, wherein the second information is configured to indicate the terminal operation status corresponding to the terminal and/or a processing duration corresponding to a first operation supported by the terminal operation status.

25.-28. (canceled)

29. A communication device, comprising:
a processor; and
a memory configured to store instructions executable by the processor,
wherein the processor is configured to determine a processing duration corresponding to a first operation related to Artificial Intelligence (AI) model processing.

30. A communication device, comprising:
a processor; and
a memory configured to store instructions executable by the processor,
wherein the processor is configured to perform the method according to claim 14.

31. (canceled)

32. A non-transitory computer-readable storage medium, wherein when instructions in the storage medium are executed by a processor of a terminal, the terminal is enabled to perform the method according to claim 1.

33. A non-transitory computer-readable storage medium, wherein when instructions in the storage medium are executed by a processor of a network device, the network device is enabled to perform the method according to any one of claim 14.
